(19) United States
(12) Patent Application Publication
(10) Pub. No.: US 2026/0023312 A1
(43) Pub. Date: Jan. 22, 2026

(54) LASER PROJECTION APPARATUS, CONTROL METHOD AND LASER UNIT CONTROL CIRCUIT

(71) Applicant: HISENSE LASER DISPLAY CO., LTD, Qingdao (CN)

(72) Inventors: Yougui LI, Qingdao (CN); Guangxue LIU, Qingdao (CN); Chaoyang REN, Qingdao (CN); Furong ZHANG, Qingdao (CN); Yi ZHANG, Qingdao (CN)

(21) Appl. No.: 19/343,737

(22) Filed: Sep. 29, 2025

Related U.S. Application Data
(63) Continuation of application No. PCT/CN2024/091226, filed on May 6, 2024.

(30) Foreign Application Priority Data
Jun. 30, 2023 (CN) 202310799073.0
Jun. 30, 2023 (CN) 202310805807.1
Jun. 30, 2023 (CN) 202310805812.2
Aug. 8, 2023 (CN) 202310992159.5

(51) Int. Cl. G03B 21/20; G09G 3/00

(52) U.S. Cl. CPC G03B 21/2053; G03B 21/2033; G09G 3/002; G03B 21/2013; G09G 2320/064; G09G 2330/021

(57) ABSTRACT

A laser projection apparatus comprising a laser unit (40), a light modulation device (50), a projection lens (60), a display control circuit (20), and a laser unit control circuit (30). The laser unit control circuit (30) comprises a controller (31) and a driving circuit (32), the controller (31) being used for generating control signals on the basis of the light source driving signal, and the driving circuit (32) being used for generating, on the basis of the control signals, a power supply signal for supplying power to the corresponding laser unit (40). The control signals comprise a first control signal and a second control signal, the first control signal being a constant-level signal and the second control signal being a PWM signal.

### CROSS-REFERENCE TO RELATED APPLICATIONS

The present application is a continuation of International Application No. PCT/CN2024/091226, filed on May 6, 2024, which claims priority to Chinese Patent Application No. 202310805812.2, filed on Jun. 30, 2023, Chinese Patent Application No. 202310799073.0, filed on Jun. 30, 2023, Chinese Patent Application No. 202310805807.1, filed on Jun. 30, 2023, and Chinese Patent Application No. 202310992159.5, filed on Aug. 8, 2023. The entire disclosures of the above-identified applications are hereby incorporated herein by reference.

### TECHNICAL FIELD

The present disclosure relates to the technical field of display, and in particular to, a laser projection apparatus, a control method, and a laser unit control circuit.

### BACKGROUND

A laser projection apparatus performs digital processing on an image signal by means of a digital light processing (DLP) technology, and a laser unit emits and projects a beam. The laser projection apparatus has the characteristics of a bright color, a high brightness, and a flexible screen size, and is widely applied. The laser projection apparatus includes a monochromatic laser unit, a dual-color laser unit, and a three-color laser unit, and each laser unit is powered by a corresponding laser unit control circuit. In the laser projection apparatus including a multi-color laser unit, the plurality of laser units illuminate alternately.

In the related art, the laser unit control circuit includes a controller, a switching tube, and an energy storage element. Upon receiving a start signal, the controller outputs a control signal, which is a pulse width modulation (PWM for short) signal and is configured to control the turning on and off of the switching tube. By turning on and off the switching tube, the energy storage element is charged and discharged. When the stored electric energy in the energy storage element reaches a reference power supply value, the energy storage element is started. Then, the brightness of the corresponding laser unit is adjusted by adjusting the duty cycle of the PWM signal.

### SUMMARY

There are provided a laser projection apparatus, a control method, and a laser unit control circuit, and the display effect of the laser projection apparatus can be improved. The technical solutions of the laser projection apparatus, the control method, and the laser unit control circuit are described below.

In a first aspect, the present disclosure provides a laser projection apparatus. The laser projection apparatus includes a laser light source, a light modulation device, a projection lens, a display control circuit, and at least one laser unit control circuit. The laser light source includes at least one laser unit, which corresponds to the at least one laser unit control circuit on a one-to-one basis, the laser unit being configured to emit a laser beam. The display control circuit is configured to output a light source driving signal and an image display driving signal, the light source driving signal including an image enable signal and a brightness control signal. The light modulation device is configured to modulate the laser beam under the drive of the image display driving signal. The projection lens is configured to receive the modulated laser beam and perform projection imaging. The laser unit control circuit includes a controller and a driving circuit, the controller being connected to the display control circuit and the driving circuit and configured to generate, on the basis of the image enable signal and the brightness control signal, control signals. The driving circuit is connected to the corresponding laser unit, the driving circuit being configured to generate, on the basis of the control signals, a power supply signal for supplying power to the corresponding laser unit. The control signals include a first control signal and a second control signal, the first control signal being a constant-level signal outputted by the controller when the image enable signal is converted from an invalid level to a valid level and the power supply signal does not reach a reference power supply value corresponding to the brightness control signal; and the second control signal being a PWM signal outputted by the controller when the image enable signal is the valid level and the power supply signal reaches the reference power supply value corresponding to the brightness control signal.

In a second aspect, the present disclosure provides a control method. The control method is applied to the laser projection apparatus in the first aspect. The control method includes: emitting, by the laser unit, a laser beam to provide the apparatus with an illumination beam; outputting, by the display control circuit, a light source driving signal and an image display driving signal, the light source driving signal including an image enable signal and a brightness control signal; modulating, by the light modulation device, the laser beam under the drive of the image display driving signal; receiving, by the projection lens, the modulated laser beam, and performing projection imaging; generating, by the controller, a control signal on the basis of the image enable signal and the brightness control signal; and generating, by the driving circuit, a power supply signal for supplying power to the corresponding laser unit on the basis of the control signals, where the control signals include a first control signal and a second control signal, the first control signal being a constant-level signal outputted by the controller when the image enable signal is converted from an invalid level to a valid level and the power supply signal does not reach a reference power supply value corresponding to the brightness control signal; and the second control signal being a PWM signal outputted by the controller when the image enable signal is the valid level and the power supply signal reaches the reference power supply value corresponding to the brightness control signal.

In a third aspect, the present disclosure provides a laser unit control circuit. The laser unit control circuit includes a controller and a driving circuit. The controller is connected to the display control circuit and the driving circuit, the controller being configured to generate, on the basis of the image enable signal and the brightness control signal, control signals. The driving circuit is connected to the corresponding laser unit, the driving circuit being configured to generate, on the basis of the control signals, a power supply signal for supplying power to the corresponding laser unit. The control signals include a first control signal and a second control signal, the first control signal being a constant-level signal outputted by the controller when the image enable signal is converted from an invalid level to a valid level and the power supply signal does not reach a reference power supply value corresponding to the brightness control signal; and the second control signal being a PWM signal outputted by the controller when the image enable signal is the valid level and the power supply signal reaches the reference power supply value corresponding to the brightness control signal.

### BRIEF DESCRIPTION OF DRAWINGS

FIG. 1 is a schematic diagram of a laser projection apparatus provided by an embodiment of the present disclosure.

FIG. 2 is a schematic diagram of a circuit architecture of a laser projection apparatus provided by an embodiment of the present disclosure.

FIG. 3 is a circuit schematic diagram of a laser projection apparatus provided by an embodiment of the present disclosure.

FIG. 4 is a circuit schematic diagram of a laser projection apparatus provided by an embodiment of the present disclosure.

FIG. 5 is a timing diagram of an image enable signal of a laser unit provided by an embodiment of the present disclosure.

FIG. 6 is a circuit schematic diagram of a laser projection apparatus provided by an embodiment of the present disclosure.

FIG. 7 is a timing diagram of respective control signals in the related art.

FIG. 8 is a timing diagram of respective control signals provided by an embodiment of the present disclosure.

FIG. 9 is a circuit schematic diagram of another laser projection apparatus provided by an embodiment of the present disclosure.

FIG. 10 is a circuit schematic diagram of another laser projection apparatus provided by an embodiment of the present disclosure.

FIG. 11 is a circuit schematic diagram of another laser projection apparatus provided by an embodiment of the present disclosure.

FIG. 12 is a circuit schematic diagram of another laser projection apparatus provided by an embodiment of the present disclosure.

FIG. 13 is a timing diagram of yet another respective control signals provided by an embodiment of the present disclosure.

FIG. 14 is a circuit schematic diagram of another laser projection apparatus provided by an embodiment of the present disclosure.

FIG. 15 is a circuit schematic diagram of another laser projection apparatus provided by an embodiment of the present disclosure.

FIG. 16 is a circuit schematic diagram of another laser projection apparatus provided by an embodiment of the present disclosure.

FIG. 17 is a circuit schematic diagram of another laser projection apparatus provided by an embodiment of the present disclosure.

FIG. 18 is a waveform diagram of an initial power supply current provided by an embodiment of the present disclosure.

FIG. 19 is a circuit schematic diagram of another laser projection apparatus provided by an embodiment of the present disclosure.

FIG. 20 is a waveform diagram of an initial power supply current provided by an embodiment of the present disclosure.

FIG. 21 is a circuit schematic diagram of another laser projection apparatus provided by an embodiment of the present disclosure.

FIG. 22 is a waveform diagram of another initial power supply current provided by an embodiment of the present disclosure.

FIG. 23 is a circuit schematic diagram of another laser projection apparatus provided by an embodiment of the present disclosure.

FIG. 24 is a circuit schematic diagram of another laser projection apparatus provided by an embodiment of the present disclosure.

FIG. 25 is a circuit schematic diagram of a current adjustment circuit provided by an embodiment of the present disclosure.

FIG. 26 is a circuit schematic diagram of another current adjustment circuit provided by an embodiment of the present disclosure.

FIG. 27 is a circuit schematic diagram of another current adjustment circuit provided by an embodiment of the present disclosure.

FIG. 28 is a circuit schematic diagram of another current adjustment circuit provided by an embodiment of the present disclosure.

FIG. 29 is a circuit schematic diagram of another laser projection apparatus provided by an embodiment of the present disclosure.

FIG. 30 is a circuit schematic diagram of another laser projection apparatus provided by an embodiment of the present disclosure.

FIG. 31 is a circuit schematic diagram of another laser projection apparatus provided by an embodiment of the present disclosure.

FIG. 32 is a circuit schematic diagram of another laser projection apparatus provided by an embodiment of the present disclosure.

FIG. 33 is a circuit schematic diagram of another current adjustment circuit provided by an embodiment of the present disclosure.

FIG. 34 is a circuit schematic diagram of another current adjustment circuit provided by an embodiment of the present disclosure.

FIG. 35 is a circuit schematic diagram of another current adjustment circuit provided by an embodiment of the present disclosure.

FIG. 36 is a circuit schematic diagram of another current adjustment circuit provided by an embodiment of the present disclosure.

FIG. 37 is a circuit schematic diagram of another laser projection apparatus provided by an embodiment of the present disclosure.

FIG. 38 is a flow diagram of a control method provided by an embodiment of the present disclosure.

FIG. 39 is a schematic diagram of a hardware structure of an electronic apparatus provided by an embodiment of the present disclosure.

### DETAILED DESCRIPTION OF THE EMBODIMENTS

The terms involved in the embodiments of the present disclosure are explained below.

Power factor correction (PFC): power factor correction, where a power factor refers to a relationship between active power and total power consumption (apparent power), i.e., the ratio of active power to total power consumption (apparent power). A basic operating principle of a PFC-regulated switching power source is to adjust the waveform of an input current by employing an inductance compensation method, such that the waveform of the input current is as similar as possible to the waveform of an input voltage, and a power factor correction value approaches 100%.

LLC: a resonant circuit that achieves a constant output voltage by controlling the switching frequency (i.e., frequency adjustment). When a one-port network including inductor, capacitor, and resistor elements has the same phase of the voltage and current waveforms of the port at some operating frequencies, the circuit resonates. The circuit that resonates is called a resonant circuit.

A rectifier bridge circuit is a rectifier circuit that is most widely used in a power source circuit, which includes 4 diodes in the same direction and a transformer. Rectification refers to the process of converting an alternating current into a direct current. By means of a device with a one-way conduction characteristic, the alternating current with changed direction and magnitude can be converted into a direct current.

The technical solutions provided by the embodiments of the present disclosure will be described below.

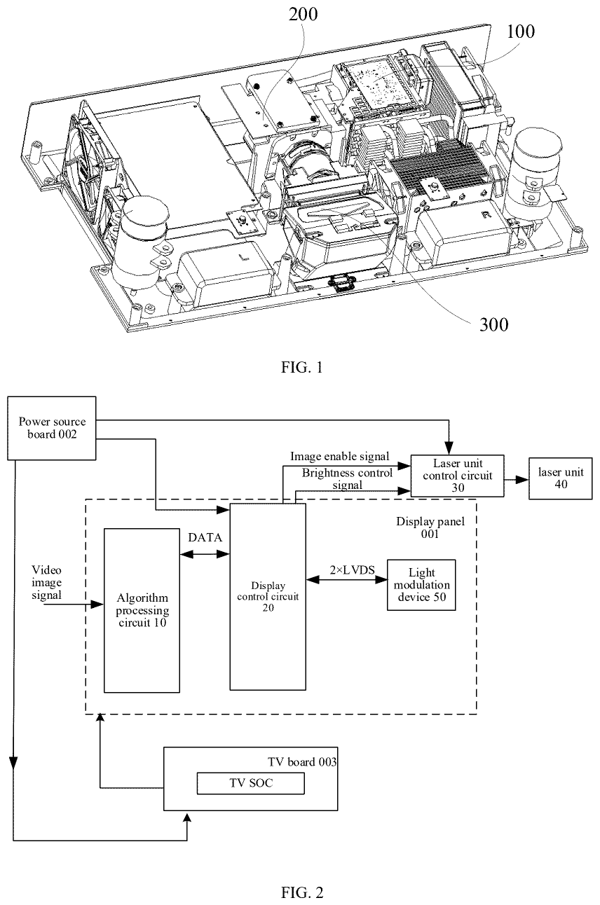

FIG. 1 is a schematic diagram of a laser projection apparatus provided by an embodiment of the present disclosure. The laser projection apparatus is a laser television, a projection apparatus of a laser beam scanning system, a head-mounted display, a stereo (three-dimensional) display, and the like.

As shown in FIG. 1, after an upper housing of the laser projection apparatus is disassembled, an internal structure, divided in terms of optical function, includes a light source 100, an optomechanical component 200, and a lens 300. The light source 100 is configured to provide an illumination beam, which is transmitted to a light modulation device and a projection lens at the back-end. The light source 100 includes a laser unit in at least one color, such as a blue laser unit, or a dual-color laser unit, such as a blue laser unit and a red laser unit, or a three-color laser light source, including laser units in red, green, and blue.

The laser beam provided by the light source 100 is emitted to an illumination light path portion in the optomechanical component 200 after being combined and shaped. In a DLP projection architecture, a digital micromirror device (DMD) chip is a key light modulation device. The DMD chip receives a drive control signal corresponding to an image signal, tens of thousands of micromirrors on the surface of the DMD chip are turned at a positive angle or a negative angle corresponding to the driving signal, and a light beam irradiating the surface of the DMD chip is reflected into the lens 300.

In some examples, the lens 300 is an ultra-short throw projection lens, which is configured to project an image beam to a projection screen, so as to display a projected image. Correspondingly, the laser projection apparatus is an ultra-short throw laser projection apparatus.

FIG. 2 shows a schematic diagram of a circuit architecture of a laser projection apparatus. As shown in FIG. 2, the laser projection apparatus includes a display panel 001, a power source board 002, and a TV board 003. The power source board 002 is respectively connected to the display panel 001 and the TV board 003. The power source board 002 is configured to supply power to devices or part of modules on the display panel 001 and the TV board 003 and also supply power to other functional modules in the laser projection apparatus, such as a human eye protection module, a fan and a WIFI module, so as to ensure normal power supply to all parts of the laser projection apparatus. In some examples, the power source board 002 is further provided with a laser unit control circuit. Alternatively, the laser unit control circuit is disposed independently from the power source board 002.

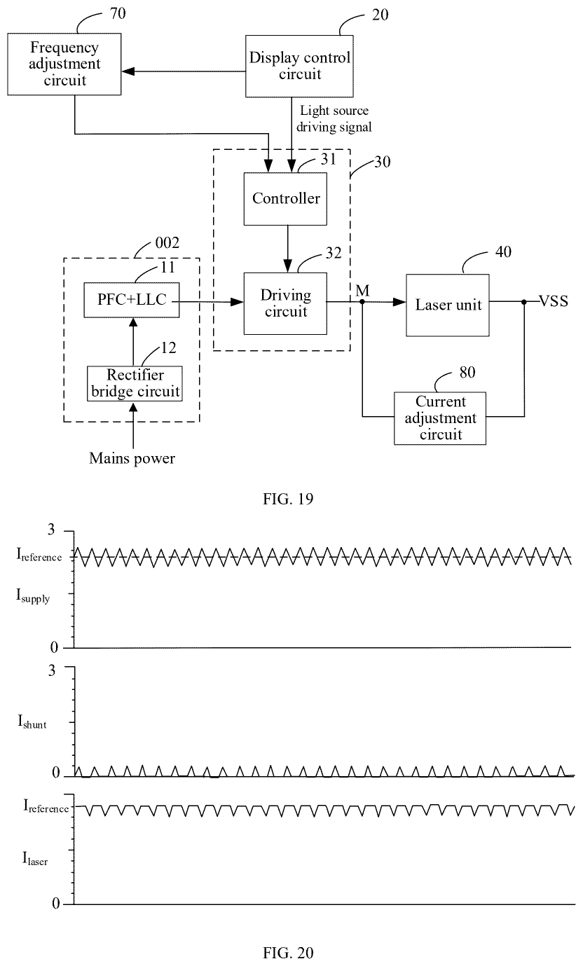

In some examples, as shown in FIG. 19, an input terminal of the power source board 002 is connected to mains power, and an output terminal thereof is connected to the laser unit control circuit 30. The power source board 002 includes a rectifier bridge circuit 12 and a power conversion circuit 11. The rectifier bridge circuit 12 is a full-bridge or half-bridge rectifier circuit, configured to rectify alternating current mains power into a direct current electric signal. The power conversion circuit 11 is a flyback circuit or a PFC+LLC circuit, configured to perform power conversion processing on the direct current electric signal, so as to output a direct current power source signal corresponding to a load.

The TV board 003 is mainly configured to receive external audio and video signals, decode the same, and output video image signals. The TV board 003 is provided with a system on chip (SoC), which can decode data in different data formats into a normalized format, and transmit the data in the normalized format through, such as a connector, to the display panel 001. The video image signals outputted by the TV board 003 are transmitted to the display panel 001.

The display panel 001 may be configured with an algorithm processing circuit 10 and a display control circuit 20, where the algorithm processing circuit 10 is configured to process the inputted video image signals, such as motion estimation and motion compensation (MEMC) frequency multiplication processing or correction of images to achieve an image-enhancing function. The display control circuit 20 is connected to the algorithm processing circuit 10, and the display control circuit 20 is configured to receive the processed video image signal data as image data to be displayed. It is to be noted that in some examples, the algorithm processing circuit 10 is achieved by a field programmable gate array (FPGA). The algorithm processing circuit 10 usually exists as a function enhancement circuit. In some low-cost solutions, the circuit part may not be disposed. The display control circuit 20 receives the video image signals outputted by the TV board 003.

The display control circuit 20 mainly includes a DLP chip and may also include a driving chip. The display control circuit 20 is configured to output an image display driving signal and a light source driving signal (also known as a laser driving signal or a dimming signal). The light source driving signal includes an image enable signal and a brightness control signal. The image display driving signal is configured to drive the light modulation device, and the light modulation device modulates the laser beam under the drive of the image display driving signal. The projection lens is configured to receive the modulated laser beam and perform projection imaging.

In the control architecture of the DLP, the light source part needs to match operating timing sequences of the DLP chip and the DMD chip. Specifically, the DLP chip outputs the image enable signal, also known as a primary light enable signal, which is usually denoted as X_EN, where X is an abbreviation of different primary light, and the brightness control signal is also outputted, the PWM signal for short. Along with the timing-based modulation process of the DMD chip for image components of different primary colors, the light source part needs to synchronously output primary color light beams of corresponding colors. That is, the DLP chip outputs the primary light enable signal to notify the laser light source to enable illumination of the laser unit of a certain color, and outputs the brightness control signal to notify a specific type of a certain laser unit in the laser light source of the brightness at which it should illuminate.

Corresponding to FIG. 2, the display control circuit 20 is configured to, on the one hand, generate the image display driving signal of the light modulation device 50 according to the image signal to be displayed. On the other hand, since the projected image is displayed, the light beam of the light source and the light modulation device need to match with each other synchronously. The display control circuit 20 further generates the light source driving signal. The light source driving signal includes the image enable signal and the brightness control signal, such as the PWM signal of the current. The image enable signal is a timing control signal, configured to coordinate timing sequences outputted by lights of different colors. The PWM signal of the current is a periodic square wave signal, configured to provide a current signal to illuminate the laser unit.

Moreover, in the schematic diagram of the circuit architecture of the laser projection apparatus shown in FIG. 2, a laser unit control circuit 30 is further included. The laser unit control circuit 30 is configured to receive the image enable signal and the brightness control signal outputted by the display control circuit 20, receive a power supply input voltage of the power source board 002, and directly control illumination of the laser unit 40.

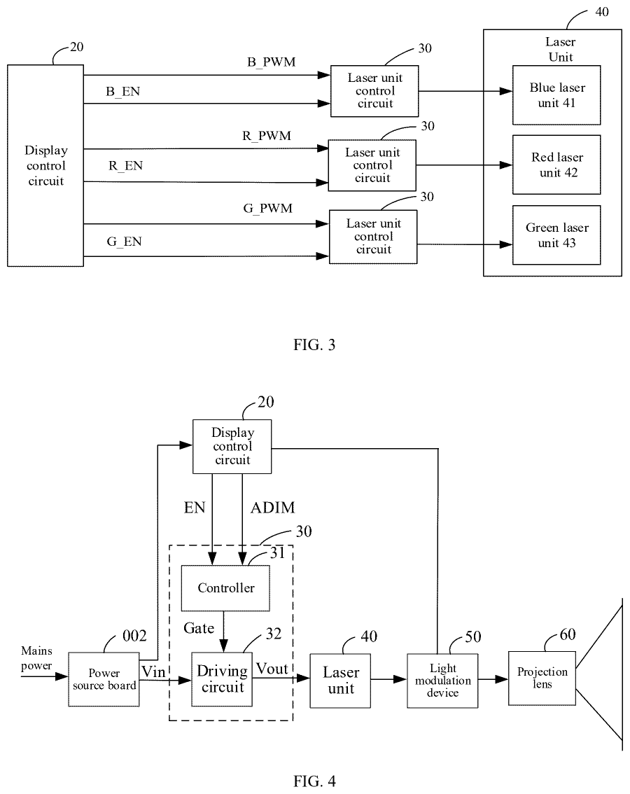

In the figure, the laser unit 40 may be a single-color laser unit or a multi-color laser unit. In some examples, as shown in FIG. 3, the laser unit 40 includes three laser units of different colors, which are respectively a blue laser unit 41 emitting a blue laser, a red laser unit 42 emitting a red laser, and a green laser unit 43 emitting a green laser. Each laser unit above may be a multi-package chip laser unit. In some examples, three light emitting chips are packaged in a package housing. In some examples, three light emitting chips are packaged in a plurality of (such as two) package housings.

In some examples, as shown in FIG. 3, the display control circuit 20, on the basis of a blue primary color component of the image to be displayed, outputs a blue PWM signal B_PWM corresponding to the blue laser unit 41, on the basis of a red primary color component of the image to be displayed, outputs a red PWM signal R_PWM corresponding to the red laser unit 42, and on the basis of a green primary color component of the image to be displayed, outputs a green PWM signal G_PWM corresponding to the green laser unit 43.

The display control circuit 20 may, on the basis of an illumination duration of the blue laser unit 41 within a driving period, output an image enable signal B_EN0 corresponding to the blue laser unit 41, on the basis of an illumination duration of the red laser unit 42 within a driving period, output an image enable signal R_EN0 corresponding to the red laser unit 42, and on the basis of an illumination duration of the green laser unit 43 within a driving period, output an image enable signal G_EN0 corresponding to the green laser unit 43. That is, the image enable signal is a periodical PWM signal. For example, when the red laser unit 42 illuminates on the basis of a high level of the corresponding image enable signal R_EN0, the other two laser units do not operate on the basis of low levels of the corresponding image enable signals, such that different laser units illuminate alternatively.

In the related art, the laser unit control circuit 30 includes a controller, a switching tube, and an energy storage element. The controller receives the corresponding image enable signals and brightness control signals. The image enable signal is configured to control a state of the controller, and when the image enable signal is converted from the low level to the high level, the controller starts to activate and outputs the PWM control signal. The control signal is configured to control the turning on and off of the switching tube, and by turning on and off the switching tube, the energy storage element is charged and discharged. When the stored electric energy in the energy storage element reaches the reference power supply value, the energy storage element is started, and then the brightness of the corresponding laser unit is adjusted by adjusting the duty cycle of the PWM signal.

However, in the related art, the start-up speed of the laser unit control circuit 30 is relatively low, such that the laser unit cannot illuminate immediately, which affects the display effect of the laser projection apparatus.

In view of the above problems, the embodiment of the present disclosure provides a laser projection apparatus. In the laser projection apparatus, when started, the laser unit control circuit 30 outputs a first control signal with a constant level and outputs a second control signal, which is the PWM signal after being started. The first control signal with a constant level, relative to the PWM signal, can charge the energy storage element continuously to increase the charge speed of the energy storage element, such that the power supply signal can rapidly reach the reference power supply value, so as to improve the start speed of the laser unit control circuit 30, thereby improving the illumination speed of the laser unit.

As shown in FIG. 4, the laser projection apparatus includes a laser light source, a light modulation device 50, a projection lens 60, a display control circuit 20, and a laser unit control circuit 30. The laser light source includes at least one laser unit 40, and the laser unit 40 is configured to emit a laser beam, so as to provide an illumination beam to the apparatus. The laser units 40 correspond to the laser unit control circuits 30 one by one.

The display control circuit 20 is configured to output a light unit driving signal and an image display driving signal. The light unit driving signal includes an image enable signal and a brightness control signal.

The light modulation device 50 is used to modulate the laser beam under the drive of the image display driving signal.

The projection lens 60 is configured to receive the modulated laser beam and perform projection imaging.

The laser unit control circuit 30 includes a controller 31 and a driving circuit 32. The controller 31 is connected to the display control circuit 20 and the driving circuit 32. The controller 31 is configured to generate, on the basis of the image enable signal and the brightness control signal, control signals (also known as driving signals). The driving circuit 32 is connected to the corresponding laser unit 40, the driving circuit 32 being configured to generate, on the basis of the control signals, a power supply signal for supplying power to the corresponding laser unit 40. The control signals include a first control signal and a second control signal. The first control signal is a constant-level signal outputted by the controller 31 when the image enable signal is converted from an invalid level to a valid level and the power supply signal does not reach a reference power supply value corresponding to the brightness control signal. The second control signal is a PWM signal outputted by the controller 31 when the image enable signal is a valid level and the power supply signal reaches the reference power supply value corresponding to the brightness control signal.

It is to be complementarily noted that the display control circuit 20 may also be known as a display control module, and the laser unit control circuit 30 may also be known as a laser unit driving module or a laser driving module. The brightness control signal may also be known as a power supply control signal.

As shown in FIG. 4, the laser unit control circuit 30 includes a controller 31 and a driving circuit 32, the controller 31 receiving the corresponding image enable signal and brightness control signal outputted by the display control circuit 20. It may be known from the above examples that the brightness control signal is configured to control the magnitude of the power supply signal outputted by the laser unit control circuit 30, so as to control the brightness of the laser unit 40.

The brightness control signal characterizes the brightness of the corresponding color in the image to be displayed. The brightness control signal may be an Autodesk digital imaging model (ADIM), and the ADIM may be an analog signal converted from a digital signal. For example, the laser unit control circuit 30 further includes a digital to analog converter (DAC), the display control circuit 20 emits a brightness control signal in a digital form, such as a PWM signal, and a DAC circuit converts the PWM signal into an ADIM in the analog format. The DAC circuit may be integrated in the display control circuit 20 or the controller 31. It is to be complementarily noted that, as for the DAC circuit integrated in the display control circuit 20, the display control circuit 20 directly transmits the brightness control signal in the ADIM format to the controller 31. For the DAC circuit integrated in the controller 31, the display control circuit 20 transmits the brightness control signal (as shown in FIG. 3) in the PWM format to the controller 31, and upon receiving the brightness control signal in the PWM format, the controller 31 converts the brightness control signal in the PWM format into the brightness control signal in the ADIM format.

The ADIM has a corresponding relationship with the reference power supply value. On the basis of the corresponding relationship, the reference power supply value corresponding to the current ADIM may be acquired, and the reference power supply value may characterize the power supply signal needed by the laser unit 40 to reach the brightness corresponding to the image to be displayed. For example, ADIM=0.1I_reference, when ADIM is 0.2 A, the corresponding reference power supply value 0.1I_reference is 2 A. It is to be noted that in the laser unit control circuit 30 of constant-current control, the reference power supply value is a reference current value, and in the laser unit control circuit 30 of constant-voltage control, the reference power supply value is a reference voltage value, To facilitate the understanding of the embodiments of the present disclosure, descriptions are all provided by taking the reference power supply value as the reference current value as an example below.

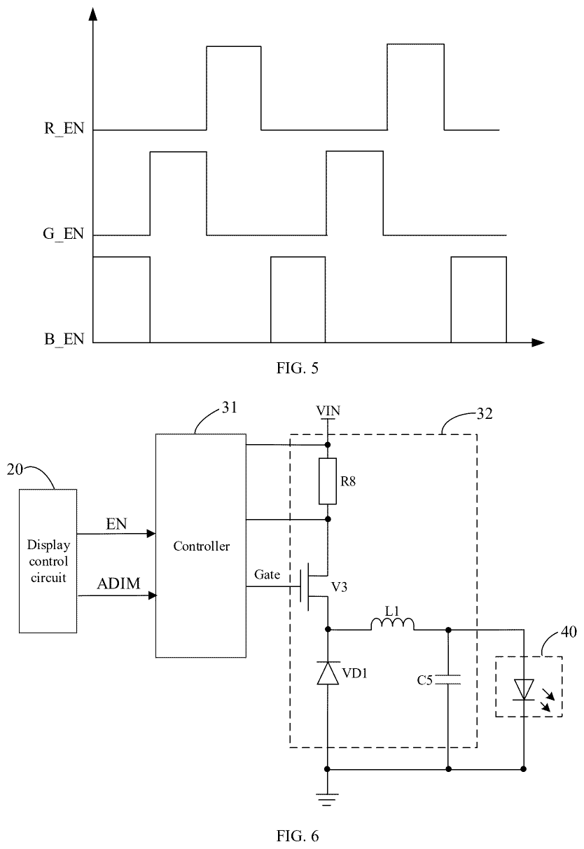

The image enable signal EN is a timing control signal, configured to coordinate timing sequences outputted by light of different colors. FIG. 5 is a timing diagram of the image enable signal EN of a laser unit in an example. As shown in FIG. 5, the valid level is a high level and the invalid level is a low level. When R_EN is at the high level, the laser unit control circuit 30 corresponding to the red laser unit 42 operates, the red laser unit 42 illuminates, the laser unit control circuit 30 corresponding to the green laser unit 43 and the laser unit control circuit 30 corresponding to the blue laser unit 41 do not operate, and the green laser unit 43 and the blue laser unit 41 do not illuminate. R_EN, G_EN, and B_EN are at the high level in sequence, such that the three laser units 40 illuminate in sequence.

It may be understood that when the EN received by the laser unit control circuit 30 is transitioned from the invalid level to the valid level, it indicates that the laser unit 40 corresponding to the laser unit control circuit 30 illuminates, and the laser unit control circuit 30 starts to activate. In this embodiment, during start, the controller 31 outputs a first control signal Gate1 at a constant level, and the constant level can increase the speed at which the power supply signal reaches the reference power supply value. Description will be made below in conjunction with examples.

FIG. 6 is a schematic structural diagram of a laser unit control circuit 30. As shown in FIG. 6, the driving circuit 32 includes an eighth resistor R8, a first inductor L1, a first diode VD1, a third switching tube V3, and a fifth capacitor C5. One terminal of the eighth resistor R8 is connected to the controller 31 and receives a power supply input signal Vin outputted by the power source board 002. The other terminal of the eighth resistor R8 is connected to the controller 31 and one terminal of the third switching tube V3. The other terminal of the third switching tube V3 is connected to a cathode of the first diode VD1 and one terminal of the first inductor L1, and a control terminal of the third switching tube V3 is connected to the controller 31 to receive the control signals. The other terminal of the first inductor L1, as an input terminal, is connected to one terminal of the fifth capacitor C5 and an anode of the laser unit 40. The other terminal of the fifth capacitor C5 is connected to the anode of the first diode VD1 and a cathode of the laser unit 40.

During operation, the controller 31 outputs the control signal Gate, and the control signal Gate is connected to the control terminal of the third switching tube V3 to control the turning on and off of the third switching tube V3. The third switching tube V3 is a P-type or N-type MOS field-effect transistor or a triode. The first inductor L1 and the fifth capacitor C5 are energy storage elements. When the third switching tube V3 is turned on (also known as conducted), the fifth capacitor C5 and the first inductor L1 are charged, and the power supply output signal Vin supplies power to the first inductor L1 and the laser unit 40. When the third switching tube V3 is turned off, the first inductor L1 and the fifth capacitor C5 discharge to output a power supply voltage Vₒᵤₜ, so as to supply power to the laser unit 40. The magnitude of Vₒᵤₜ is determined by an on-off duration of the third switching tube V3. The longer the third switching tube V3 turned on, the shorter the off duration, and the greater the Vₒᵤₜ, vice versa. Therefore, the on-off duration of the third switching tube V3 may be controlled on the basis of the duty cycle of the control signal, such that the power supply current of the laser unit 40 is controlled. Both terminals of the eighth resistor R8 are connected to different pins of the controller 31. The eighth resistor R8 is a sampling resistor. The power supply current flowing through the laser unit 40 is acquired on the basis of the voltages (or currents) at both ends of the sampling resistor. If the power supply current of the laser unit 40 is less than the reference current value, the duty cycle of the driving signal Gate is decreased, and the power supply current of the laser unit 40 is increased; on the contrary, if the power supply current of the laser unit 40 is greater than the reference current value, the duty cycle of the driving signal Gate is increased, and the power supply current of the laser unit 40 is decreased, such that the power supply current of the laser unit 40 is maintained at the reference current value corresponding to the current brightness control signal ADIM.

FIG. 6 is an example in which the laser unit control circuit 30 is a buck circuit. In practical application, the laser unit control circuit 30 may also be a boost circuit, which is not limited in this embodiment.

It is to be noted that continuously referring to FIG. 6, before the laser unit control circuit 30 is started, the electric quantities in the first inductor L1 and the fifth capacitor C5 are zero. During the start, it needs to charge the first inductor L1 and the fifth capacitor C5 first, and the first inductor L1 blocks the direct current, such that the power supply current flowing through the laser unit 40 is gradually increased to reach the reference current value. In the related part, during the start, the controller 31 outputs a PWM signal of a fixed frequency as the control signal. Thus, before the power supply current flowing through the laser unit 40 reaches the reference current value, an intermittent charge process occurs, such that the duration when the reference current value is reached is relatively long. In this embodiment, during the start, the first control signal at a constant level is outputted. Since the first control signal is at the constant level, the third switching tube V3 is continuously conducted, the first inductor L1 and the fifth capacitor C5 are continuously charged, such that the power supply current flowing through the laser unit 40 can reach the reference current value rapidly, thereby increasing the start speed.

An illustrative description will be made below in conjunction with a real scenario: FIG. 7 is a timing diagram of respective control signals in the related art. As shown in FIG. 7, the invalid level is the low level, and the valid level is the high level. At time t1, the image enable signal EN transitions from the low level to the high level. When the EN is at the low level, the laser unit control circuit 30 enters a standby state, such that t2-t1 time is the time when the controller 31 is started and responds. After the time t2, the controller 31 starts to output the PWM control signal Gate, the first inductor L1 and the fifth capacitor C5 start to charge, no current is at the laser unit 40 in this stage, and the duration of this stage is in direct proportion to the storage capacities of the first inductor L1 and the fifth capacitor C5. From time t3, the power supply current of the laser unit 40 is gradually increased to reach the reference current value at time t4. Since the third switching tube V3 is turned off when the PWM signal is at the low level, the first inductor L1 and the fifth capacitor C5 cannot be charged and can only be charged at the high level. Therefore, the power supply current of the laser unit 40 can reach the reference current value after a plurality of periods, such that t4-t3 will be relatively long.

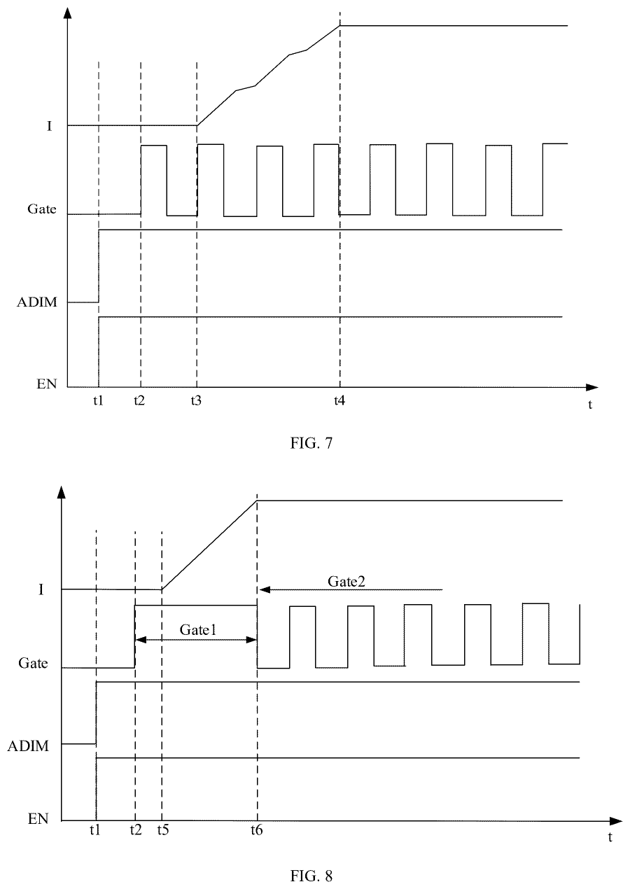

FIG. 8 is a timing diagram of respective control signals provided in an embodiment of the present disclosure. As shown in FIG. 8, from time t2, the controller 31 outputs the first control signal Gate 1 at the constant level, such that the second switching tube V2 can be turned on persistently to continuously charge the first inductor L1 and the fifth capacitor C5. Therefore, in this embodiment, the duration t5-t2 in which the first inductor L1 and the fifth capacitor C5 are fully charged is shorter than t3-t2 in the related art. In addition, the power supply currents at both terminals of the laser unit 40 will also be increased rapidly. Therefore, the duration t6-t5 is shorter than the duration t4-t3. Therefore, this embodiment can improve the start speed of the laser unit control circuit 30.

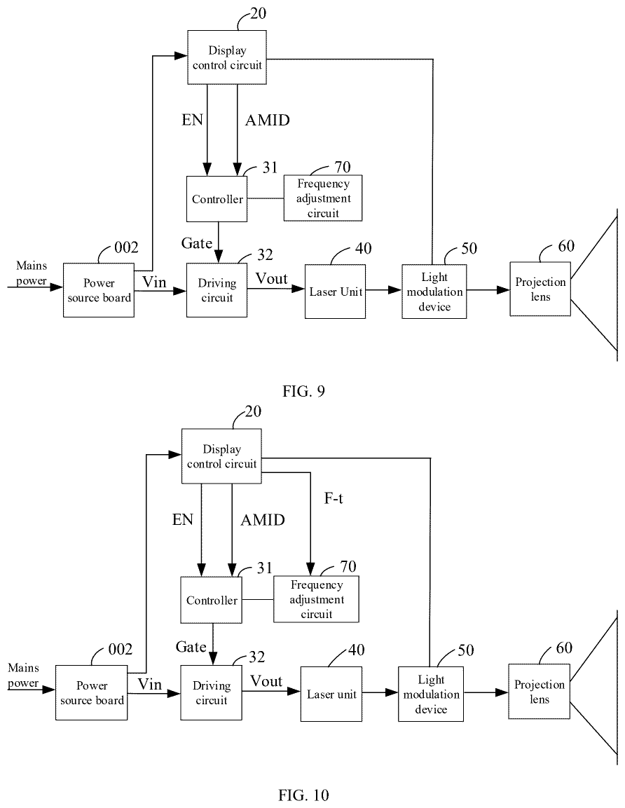

In some examples, as shown in FIG. 9, the laser projection apparatus further includes a frequency adjustment circuit 70. The frequency adjustment circuit 70 is coupled to the controller 31, and the frequency adjustment circuit 70 is configured to control the controller 31 to output the control signal of the first frequency when the image enable signal is converted from the invalid level to the valid level and the power supply signal does not reach the reference power supply value corresponding to the brightness control signal and control the controller 31 to output the control signal of the second frequency when the image enable signal is at the valid level and the power supply signal reaches the reference power supply value corresponding to the brightness control signal. The first frequency is less than the second frequency, the control signal of the first frequency includes the first control signal, and the control signal of the second frequency includes the second control signal. The frequency adjustment circuit 70 may also be known as a frequency adjustment module.

In some examples, the controller 31 is a processor having arithmetic and processing functions, such as a microcontroller unit (MCU) or other processing chips. The controller 31 has a plurality of input pins and output pins. A preset control program is written into the controller 31, and the controller 31 receives the light source driving signal and the sampled power supply current of the laser unit 40. Under control of the control program, the controller 31 generates the control signal Gate on the basis of the power supply current and the light source driving signal.

The frequency adjustment circuit 70 in the embodiment of the present disclosure is configured to control the frequency of the control signal Gate outputted by the controller 31, and the control signal Gate in the related art is at a fixed frequency. In the embodiment of the present disclosure, through the frequency adjustment circuit 70, when the image enable signal EN is transitioned from the invalid level to the valid level, i.e., during start, the controller 31 is controlled to output the control signal of the first frequency till the power supply current of the laser unit 40 reaches the reference current value. Then, the controller outputs the control signal of the second frequency. The first frequency is less than the second frequency. As long as the first frequency is set low enough, the control signal of the first frequency is at a constant level all the time before the power supply current of the laser unit 40 reaches the reference current value. This constant level is the first control signal.

For example, the first frequency is 50 HZ and the second frequency is 500 kHz, so the time when the control signal of the first frequency is maintained at the constant level is 0.02 s, which is much longer than the duration when the power supply current of the laser unit 40 reaches the reference current value. Therefore, if the time when the control signal of the first frequency is maintained at the constant level is 0.02 s, it may be considered as the first control signal.

In some examples, as shown in FIG. 10, the display control circuit 20 is further connected to the frequency adjustment circuit 70. The display control circuit 20 is configured to output the control signal of the first frequency when the image enable signal EN is converted from the invalid level to the valid level and the power supply signal does not reach the reference power supply value corresponding to the brightness control signal and output the control signal of the second frequency when the image enable signal is at the valid level and the power supply signal reaches the reference power supply value corresponding to the brightness control signal. The frequency adjustment circuit 70 is configured to, upon receiving the first frequency adjustment signal, control the controller 31 to output the control signal of the first frequency; and upon receiving the second frequency adjustment signal, control the controller 31 to output the control signal of the second frequency. That is, the display control circuit 20 indicates the frequency adjustment circuit 70 to adjust the frequency of the control signal outputted by the controller 31 by way of transmitting the frequency adjustment signal to the frequency adjustment circuit 70. The frequency adjustment signal may also be known as a frequency indication signal.

In this implementation, the display control circuit 20 acquires the state of the laser unit control circuit 30 through the image enable signal EN and the power supply current of the laser unit 40, and outputs the first frequency adjustment signal when the laser unit control circuit 30 is started, and outputs the second frequency adjustment signal after the laser unit control circuit is started. The frequency adjustment circuit 70 controls the controller 31 to output the control signals of the different frequencies on the basis of different frequency adjustment signals.

There are various ways of acquiring the power supply current of the laser unit 40 by the display control circuit 20. For example, the controller 31 may transmit the power supply current of the laser unit 40 collected by the eighth resistor R8 to the display control circuit 20, such that the display control circuit 20 acquires the power supply current of the laser unit 40. The display control circuit 20 may also directly acquire voltages at both terminals of the eighth resistor R8 to acquire the power supply current of the laser unit 40.

In some examples, as shown in FIG. 11, the frequency adjustment circuit 70 includes an external resistor circuit 71. The external resistor circuit 71 is connected to the display control circuit 20 and a frequency setting pin of the controller 31. The external resistor circuit 71 is configured to, upon receiving the first frequency adjustment signal, adjust a resistance value of the external resistor circuit 71 to a first resistance value, and upon receiving the second frequency adjustment signal, adjust the resistance value of the external resistor circuit 71 to a second resistance value. The controller 31 is configured to, on the basis of the external resistor circuit 71 of the first resistance value, generate the control signal of the first frequency, and on the basis of the external resistor circuit 71 of the second resistance value, generate the control signal of the second frequency. The external resistor circuit 71 may also be known as an external resistor module.

In the embodiment of the present disclosure, the external resistor circuit 71 is connected between the display control circuit 20 and the frequency setting pin Fset of the controller 31, and the pin Fset of the controller 31 is an external oscillation frequency timing resistor pin of the controller 31. The frequency of the control signal is usually set with the resistance value of the external resistor connected to the pin Fset. A calculation formula of the frequency f of the control signal may be as follows: f=1/Rset*CT, where Rset is the resistance value of the external resistor of the pin Fset of the controller 31, and CT is the capacitance of the internal capacitor of the controller 31. In the related art, Rset is a constant value, such that the frequency of the control signal is a constant value. In this embodiment, the external resistor circuit 71 is connected to the pin Rset. Since the resistance value of the external resistor circuit 71 varies on the basis of the frequency adjustment signal F-t, during operation, the frequency of the driving signal also varies along with the variation of the resistance value of the external resistor circuit 71, such that the controller 31 may be controlled to output control signals with different frequencies.

Continuously referring to FIG. 11, the external resistor circuit 71 includes a first switching tube V1, a first resistor R1, and a second resistor R2. One terminal of the first switching tube V1 is connected to the frequency setting pin of the controller 31, the other terminal of the first switching tube V1 is connected to one terminal of the first resistor R1, and a control terminal of the first switching tube V1 is connected to the display control circuit 20. The other terminal of the first resistor R1 is grounded. One terminal of the second resistor R2 is connected to one terminal of the first switching tube V1 and the frequency setting pin of the controller 31, and the other terminal of the second resistor R2 is connected to the other terminal of the first resistor R1 and is grounded.

The first switching tube V1 is a P-type or N type MOS field-effect transistor or a triode, which is not limited herein. A P-type triode is taken as an example. During operation, the control terminal of the first switching tube V1 receives the frequency adjustment signal F-t, where the first frequency adjustment signal and the second frequency adjustment signal are level signals with different amplitudes. The triode is controlled to operate in different operating areas on the basis of different levels, such that the impedance of the triode is controlled. If the triode operates in a saturation region, the impedance of the triode is minimum; if the triode operates in an amplifier region, the impedance of the triode increases along with a decrease in the amplitude of the level; and when the triode is turned off, the impedance is maximum. The first resistor R1 is connected in series to the first switching tube V1. Therefore, the resistance value of the circuit where the first resistor R1 and the first switching tube V1 are located varies therewith. The first resistor R1 can also prevent the circuit from being short-circuited when the first switching tube V1 operates in the saturation region. The second resistor R2 is connected in parallel to the first switching tube V1. When the impedance of the first switching tube V1 decreases, the resistance value of the external resistor circuit 71 decreases correspondingly. Therefore, the external resistor circuit 71 may control the variation of the resistance value itself on the basis of the frequency adjustment signal F-t.

Except that the controller 31 outputs the first control signal and the second control signal on the basis of the variation of the resistance value of the external resistor circuit 71, in some other examples, when outputting the first control signal, the controller 31 shields the resistance value signal of the external resistor circuit 71 and outputs the first control signal on the basis of an internal logic. In this case, the external resistor circuit 71 may have a fixed resistance value.

It is to be complementarily noted that as shown in FIGS. 7 and 8, the laser unit control circuit 30, upon receiving the image enable signal at the invalid level, is in the standby state. Therefore, when the laser unit control circuit starts to activate, the controller 31 needs a period of time to respond. To further increase the start speed of the laser unit control circuit 30, in some examples, the controller 31 is further configured to enter the standby state when the first duration in which the image enable signal is at the invalid level exceeds a predetermined duration; or not entering the standby state. The predetermined duration is shorter than the period of the image enable signal.

It may be known from the above embodiment that the image enable signal is the PWM signal, with the period being an operating period of the laser unit 40. Each period of the image enable signal includes the invalid level and the valid level. By taking the laser projection apparatus including three-color laser units 40 as an example, the red laser unit 42 illuminates when the R-EN is at the valid level. When R-EN is at the invalid level, one of the other two laser units 40 illuminates, and the three-color laser units 40 illuminate in sequence in each period. It may be understood that when R-EN is at the invalid level, there exist two probabilities: I, G-EN, or B-EN is at the valid level, and in this case, the current invalid level is the level in a normal period of the image enable signal. II, either G-EN or B-EN is at the invalid level, that is, the laser projection apparatus does not operate, all laser units 40 do not illuminate. In this embodiment, the predetermined duration exceeding the period of the image enable signal is set. When the first duration during which the image enable signal is at the invalid level exceeds the predetermined duration, it indicates that the current laser projection apparatus does not operate, and in this case, the controller 31 enters the standby state. When the first duration does not exceed the predetermined duration, it considers that the current invalid level is the level in the normal period of the image enable signal. In this scene, the controller 31 does not enter the standby state, such that when the laser units 40 are started alternatively in the period, the laser units are not re-started, and therefore, the start speed of the laser unit control circuit 30 can be further increased.

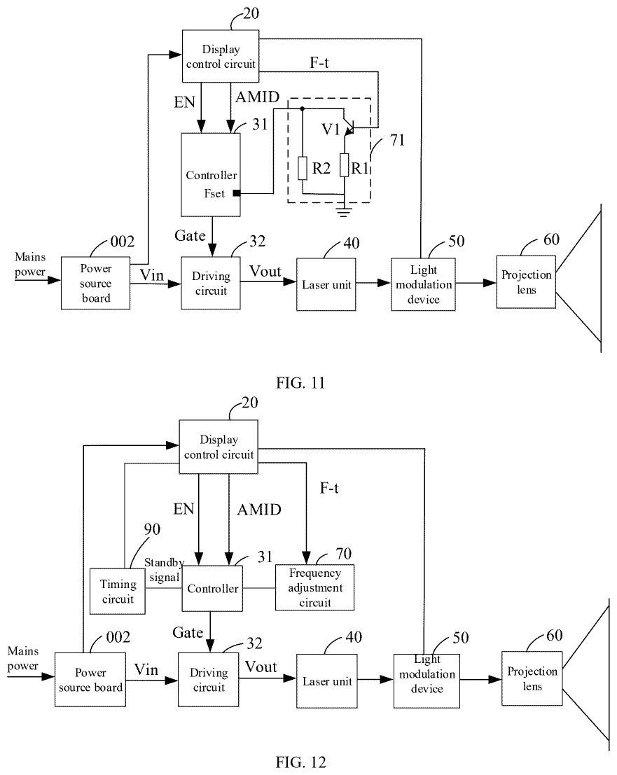

In some examples, as shown in FIG. 12, the laser projection apparatus may further include a timing circuit 90. The timing circuit 90 is coupled to the controller 31 and the display control circuit 20, and the timing circuit 90 is configured to record the first duration and transmit a standby signal to the controller 31 when the first duration exceeds the predetermined duration. The controller 31 is configured to, upon receiving the standby signal, enter the standby state; or not entering the standby state.

The timing circuit may also be known as a timing module. The timing circuit 90 is a processor having a timing function. The timing circuit 90 may be integrated in the display control circuit 20 or the controller 31, and may also be connected to the controller 31 and the display control circuit 20 as an independent unit. The timing circuit 90 may transmits the standby signal to the controller 31 when the first duration exceeds the predetermined duration, such that the controller 31 enters the standby state on the basis of the standby signal.

A starting flow of the laser unit control circuit 30 is exemplarily introduced below. The laser projection apparatus includes a three-color laser unit 40, the invalid level is the low level, and the valid level is the high level. The display control circuit 20 respectively transmits the image enable signal EN and the brightness control signal ADIM to the laser unit control circuits 30 corresponding to the three laser units 40. The image enable signal R-EN of the laser unit control circuit 30 corresponding to the red laser unit 42 is R-EN, the image enable signal G-EN of the laser unit control circuit 30 corresponding to the green laser unit 43 is G-EN, and the image enable signal B-EN of the laser unit control circuit 30 corresponding to the blue laser unit 41 is B-EN.

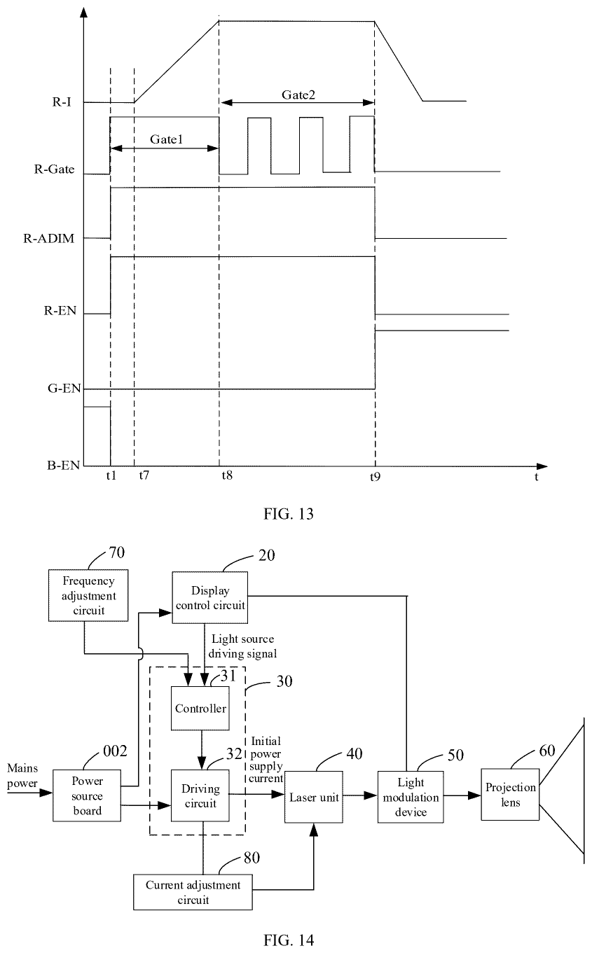

FIG. 13 is a timing diagram of yet another respective control signals provided by an embodiment of the present disclosure. As shown in FIG. 13, before time t1, B-EN is at the high level, the blue laser unit 41 illuminates, and G-EN and R-EN are at the low level, the green laser unit 43 and the red laser unit 42 do not operate. At the time t1, R-EN is converted from the low level to the high level, B-EN and G-EN are at the low level, the display control circuit 20 outputs the first frequency adjustment signal to the external resistor circuit 71 corresponding to the red laser unit 42, the resistance value of the external resistor circuit 71 corresponding to the red laser unit 42 increases, the controller 31 corresponding to the red laser unit 42 outputs the first control signal with the low frequency, and the first control signal with the low frequency includes the first control signal at the constant level. The controller 31 in the laser unit control circuit 30 corresponding to the red laser unit 42 is not in the standby state before the time t1, and can be directly started after the controller is energized. Therefore, the start time of the controller 31 does not need to be controlled at present. In the t7-t1 stage, on the basis of the first control signal Gate1 at the constant level, the capacitor and inductor in the driving circuit 32 corresponding to the red laser unit 42 are rapidly charged. From the time t7, the power supply current flowing through the red laser unit 42 is gradually increased, the reference current value corresponding to the current brightness control signal ADIM is 3 A; in the t8-t7 stage, the power supply current of the red laser unit 42 is increased from 0 to 3 A; and at the time t8, the laser unit control circuit 30 corresponding to the red laser unit 42 starts to activate. The display control circuit 20 outputs the second frequency adjustment signal, the resistance value of the external resistor circuit 71 decreases, the controller 31 corresponding to the red laser unit 42 outputs the second control signal with the high frequency, and the laser unit control circuit 30, on the basis of the duty cycle of the second control signal Gate2 with the high frequency, adjusts the outputted power supply voltage, so as to control the brightness of the red laser unit 42.

Then, at time t9, R-EN is converted to the low level, G-EN is converted to the high level, the red laser unit 42 gradually extinguishes, and the green laser unit 43 gradually illuminates. The timing circuit 90 records the duration when R-EN is at the low level. If the duration at the low level reaches the predetermined duration, it indicates that the current laser projection apparatus does not operate, and the controller 31 is controlled to enter the standby state till the laser projection apparatus operates again.

In addition, in the related art, after the laser unit 40 illuminates, the controller 31 of the laser unit control circuit 30 outputs the control signal of the fixed frequency (i.e., the control signal of the second frequency) to drive the turning on and off of the switching tube and control the on-off duration of the switching tube by means of the duty cycle of the control signal, so as to control the magnitude of the power supply voltage that supplies power to the laser unit 40.

However, high-frequency on-off of the switching tube will cause the laser unit control circuit 30 to generate strong electro magnetic interference (EMI) signals, which further affect normal power supply of the laser unit control circuit 30 to the laser unit 40.

In order to improve the above technical problems, in some examples, as shown in FIG. 14, the laser projection apparatus includes a frequency adjustment circuit 70, and the frequency adjustment circuit 70 is coupled to the controller 31. The frequency adjustment circuit 70 is configured to adjust the frequency of the second control signal outputted by the controller 31.

The frequency of the second control signal outputted by the controller 31 may be understood as the operating frequency of the controller 31.

In the embodiments of the present disclosure, the display control circuit 20, on the basis of a video signal, outputs the light source driving signal to the controller 31. The light source driving signal may be a pulse width modulation (PWM) signal. The controller 31, on the basis of the light source driving signal, controls the driving circuit 32 to output a corresponding initial power supply current, so as to control the brightness of the laser unit 40. Under the action of the frequency adjustment circuit 70, the controller 31 may operate at different operating frequencies, so the focused electromagnetic radiation when the controller operates at a fixed operating frequency can be dispersed, such that the electromagnetic interference of the laser unit control circuit 30, which supplies power can be reduced.

During practical operation, the frequency adjustment circuit 70 may periodically control the controller 31 to drive the driving circuit 32 to operate at different operating frequencies.

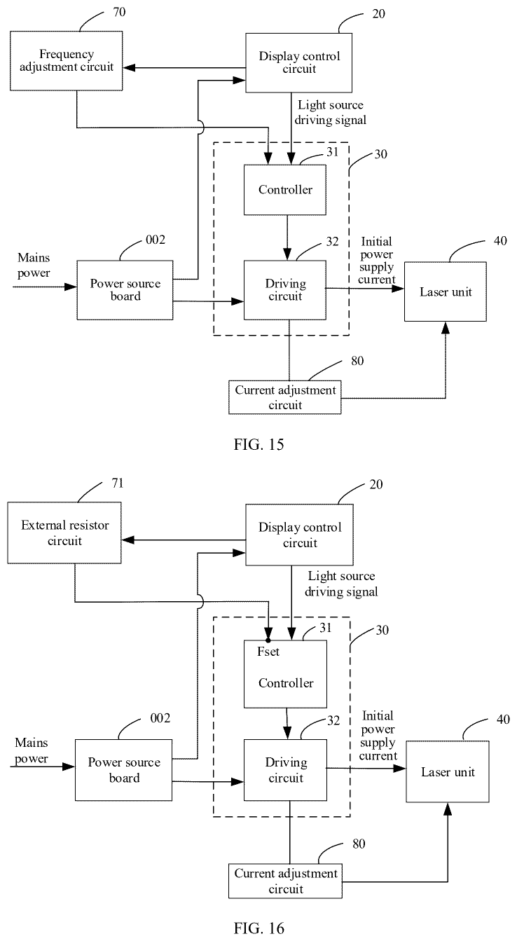

In some examples, as shown in FIG. 15, the display control circuit 20 is further connected to the frequency adjustment circuit 70, and the display control circuit 20 is configured to output a frequency adjustment signal to the frequency adjustment circuit 70. The frequency adjustment circuit 70 is configured to, on the basis of the frequency adjustment signal, adjust the frequency of the second control signal outputted by the controller 31. That is, the display control circuit 20 indicates the frequency adjustment circuit 70 to adjust the frequency of the control signal outputted by the controller 31 by way of transmitting the frequency adjustment signal to the frequency adjustment circuit 70. The frequency adjustment signal may also be known as a frequency indication signal.

The display control circuit 20 may have a clock function, set the periodically changing frequency adjustment signal on the basis of the clock function, and output the frequency adjustment signal to the frequency adjustment circuit 70. The frequency adjustment circuit 70, on the basis of the frequency adjustment circuit, enables the controller 31 to output the second control signals with different frequencies.

In some examples, as shown in FIG. 16, the frequency adjustment circuit 70 includes an external resistor circuit 71, the external resistor circuit 71 being connected to the display control circuit 20 and a frequency setting pin of the controller 31, and the external resistor circuit 71 being configured to adjust the resistance value of the external resistor circuit 71 according to the frequency adjustment signal, so as to adjust the frequency of the second control signal outputted by the controller 31.

In the laser projection apparatus provided by this embodiment, the external resistor circuit 71 is connected between the display control circuit 20 and the frequency setting pin Fset of the controller 31. The Fset pin of the controller 31 is an external oscillation frequency timing resistor pin of the controller 31, and the frequency of the control signal is usually set with the resistance value of the external resistor connected to the pin Fset. A calculation formula of the frequency f of the control signal may be as follows: f=1/Rset*CT, where Rset is the resistance value of the external resistor of the pin Fset of the controller 31, and CT is the capacitance of the internal capacitor of the controller 31. In the related art, Rset is a constant value, such that the frequency of the control signal is a constant value. In this embodiment, the external resistor circuit 71 is connected to the pin Rset. Since the resistance value of the external resistor circuit 71 varies on the basis of the frequency adjustment signal, during operation, the frequency of the second control signal also varies along with the variation of the resistance value of the external resistor circuit 71, such that the frequency of the second control signal may vary.

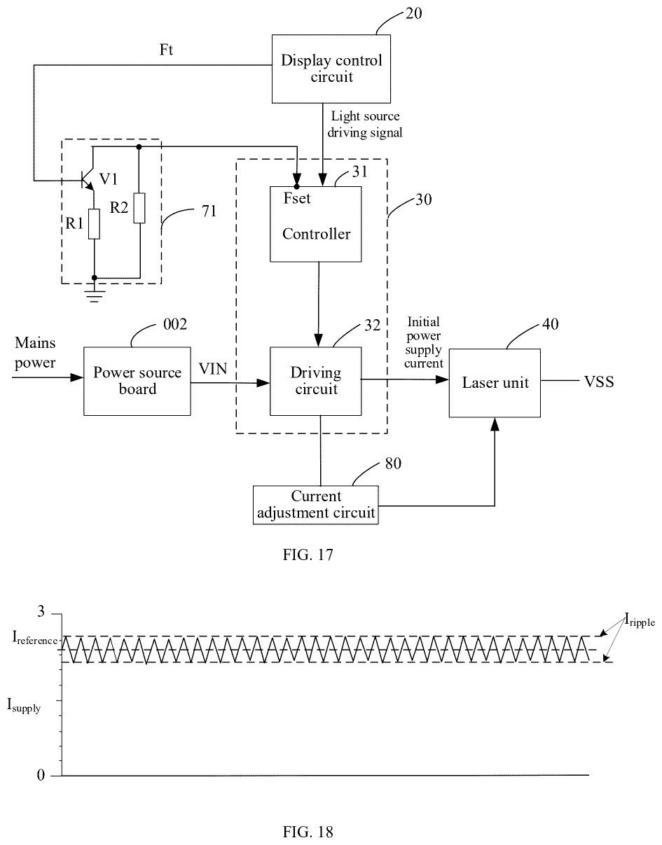

In some examples, as shown in FIG. 17, the external resistor circuit 71 includes a first switching tube V1, a first resistor R1, and a second resistor R2. A specific structure of the external resistor circuit 71 may refer to the content above, which is not repeatedly described herein.

In some examples, the frequency of the second control signal outputted by the controller 31 may at least include a first operating frequency and a second operating frequency. The first operating frequency is the frequency of the second control signal outputted by the controller 31 when the first switching tube V1 is turned off. The second operating frequency is the frequency of the second control signal outputted by the controller 31 when the first switching tube V1 is turned on.

For example, in the power supply process of the laser unit control circuit 30, the controller 31 first controls the driving circuit 32 to operate at the first operating frequency. In a first duration, the frequency adjustment circuit 70 controls the controller 31 to control the driving circuit 32 to operate at the second operating frequency. After lasting for a second duration, the frequency adjustment circuit 70 continuously controls the driving circuit 32 to operate at the first operating frequency. Thus, the frequency adjustment circuit 70 periodically controls the controller 31 repeatedly to operate at the first and second operating frequencies.

The interval time during which the controller 31 drives the driving circuit 32 to operate at the first operating frequency for two adjacent time is the period in which the controller 31 operates at the first operating frequency. The interval time during which the controller 31 drives the driving circuit 32 to operate at the second operating frequency for two adjacent time is the period in which the controller 31 operates at the second operating frequency.

In some examples, the period in which the controller 31 operates at the first operating frequency is not greater than the period in which the controller 31 operates at the second operating frequency. That is, in the power supply process of the driving circuit 32, the controller 31 drives the driving circuit 32 to operate at the first operating frequency in most of the time. In comparison, the duration in which the controller drives the driving circuit 32 to operate at the second operating frequency is relatively short. Thus, the negative power supply impact generated by the variation of the operating frequency may be reduced. For example, in the process of controlling the driving circuit 32 to operate at the second operating frequency, ripples may be generated, which affect the normal power supply. The time in which the driving circuit 32 is controlled to operate at the second operating frequency is set shorter, which may reduce the generation of the ripples.

In some examples, a difference between the second operating frequency and the first operating frequency is within a first range. A difference between an upper limit value and a lower limit value of the first range is less than the first operating frequency. Thus, the power supply fluctuation of the laser unit control circuit 30 may be reduced, such that the power supply stability is maintained.

For example, the first operating frequency is 500 kHz, the second operating frequency is 520 kHz, and the difference therebetween is 20 kHz, which is within the first range −30 kHz to +30 kHz. The difference (60 kHz) between the upper limit value and the lower limit value is much less than 500 kHz.

During practical application, the second operating frequency may be a single frequency, i.e., the controller 31, on the basis of two frequency points, drives the driving circuit 32 to operate. The second operating frequency may also include a plurality of second sub-operating frequencies. The controller 31, on the basis of the plurality of second sub operating frequencies and the first operating frequency, controls the driving circuit 32 to operate, i.e., disperses the electromagnetic interference generated by the first operating frequency. Therefore, the plurality of second sub operating frequencies can improve the effect of reducing radiated interference. The plurality of second sub operating frequencies may be continuous operating frequencies or discontinuous operating frequencies.

For the plurality of continuous second sub operating frequencies, it may be understood that the second operating frequency varies within a preset range. For example, a variation range is 480-520 kHz. In combination with the above examples, after the frequency adjustment circuit 70 enters a frequency modulation mode, the controller 31 is controlled to control the driving circuit 32 to operate at the second operating frequency varying continuously from 480 kHz to 520 kHz.

For the plurality of discontinuous second sub operating frequencies, the controller 31 controls the driving circuit 32 to operate respectively at the plurality of second sub operating frequencies.

The magnitude relationship between the plurality of second sub operating frequencies and the first operating frequency is not limited in the embodiment of the present disclosure.

For example, the plurality of second sub operating frequencies are greater than the first operating frequency. That is, in this example, the electromagnetic interference is reduced by the plurality of sub-frequencies greater than the first operating frequency.

For another example, the plurality of second sub operating frequencies are less than the first operating frequency. That is, the electromagnetic interference is reduced by the plurality of sub-frequencies less than the first operating frequency.

For another example, the plurality of second sub operating frequencies includes the minimum second sub operating frequency and the maximum second sub operating frequency, and the first operating frequency is greater than the minimum second sub operating frequency and less than the maximum second sub operating frequency.

In addition, in the related art, the laser unit control circuit 30 is configured with elements such as the switching tube, the capacitor, and the inductor. The magnitude of the output voltage is controlled by turning on and off the switching tube, such that the power supply current of the laser unit 40 is controlled. However, the high-frequency on and off of the switching tube will cause the initial power supply current to generate ripples. FIG. 18 is a waveform diagram of a power supply current in an example. As shown in FIG. 18, the initial power supply current will generate harmonic waves, i.e., ripples, on the basis of the reference current, that is, the power supply current I_{supply} is equal to the sum of the reference current Iₚᵣₑₛₜ and the ripple signal Iᵣᵢₚₚₗₑ. Moreover, the size of the ripples is affected by many factors. In the three-color laser television, red, blue, and green laser units correspond to the laser unit control circuits 30. During operation, the three laser units illuminate alternatively in sequence. When the laser units 40 are switched, if the increasing or decreasing rate of the operating current of the laser units 40 is too low, the operation duration is too long, resulting in a scene where the laser units 40 with different colors illuminate at the same time, which will affect the quality of the picture. The increasing and decreasing duration of the operation current is in direct proportion to the inductance. Therefore, in the laser television in some examples, the increasing and decreasing duration of the operating current is shortened by reducing the inductance. However, the inductance L and the ripple current Iᵣᵢₚₚₗₑ have the following relationship.

$$L = \frac{{V}_{OUT} \times {T}_{off}}{{I}_{ripple}}$$

That is, when the inductance and capacitance are reduced, the ripples of the current will increase. The increased ripples will reduce the power supply efficiency of the laser unit control circuit 30 and even cause a surge voltage or current, which burns the laser unit 40. Therefore, it is important to reduce the ripples in the power supply current of the laser unit 40.

In addition, the controller 31 operates at different operating frequencies by the frequency adjustment circuit 70 in the embodiment of the present disclosure. However, when the adjustment range of the operating frequency is enlarged, particularly when the operating frequency is low, the initial power supply current of the laser unit control circuit 30 will generate larger ripples. On the contrary, further enhancement of the ripples also limits the adjustment range of the operating frequency. Therefore, in the embodiment of the present disclosure, the current adjustment circuit 80 is configured to eliminate the ripples generated by frequency spreading of the operating frequency in the initial power supply current. The current adjustment circuit 80 may also be known as a current adjustment module.

The solution of eliminating the ripples on the basis of the current adjustment circuit 80 will be illustratively described below.

As shown in FIGS. 14-17, the current adjustment circuit 80 provided in the embodiment of the present disclosure is connected to the driving circuit 32 and the laser unit 40, and the current adjustment circuit 80 is configured to, on the basis of a comparison result of the initial power supply current and a reference current, adjust a current flowing through the laser unit 40, such that the absolute value of the difference between the current flowing through the laser unit 40 and the reference current is less than the absolute value of the difference between the initial power supply current and the reference current.

The reference current is a current capable of enabling the laser unit 40 to reach the brightness corresponding to the light source driving signal. It may be understood that the light source driving signal corresponds to the reference current. The reference current is an ideal current under the current light source driving signal and is also a theoretical output value of the initial power supply current. The initial power supply current is compared with the reference current. When the initial power supply current is greater than the reference current, it indicates that the initial power supply current exists in a ripple current greater than zero. In this scene, the current adjustment circuit 80 adjusts the current flowing through the laser unit 40, such that the current flowing through the laser unit 40 is less than the initial power supply current, which is equivalent to reducing the ripple current in the current flowing through the laser unit 40. On the contrary, when the initial power supply current is less than the reference current, it indicates that the initial power supply current exists in a ripple current less than zero. The current adjustment circuit 80 adjusts the current flowing through the laser unit 40, such that the current flowing through the laser unit 40 is greater than the initial power supply current, which is equivalent to compensating the ripple current less than zero in the current. The ripples in the current flowing through the laser unit 40 are eliminated.

It is to be noted that on the basis of Ohm's Law, under a condition of a certain load, the voltage is in direct proportion to the current, that is, when the ripple current in the current flowing through the laser unit 40 is eliminated, the ripple voltage in the power supply voltage of the laser unit 40 is also eliminated.

The current adjustment circuit 80 will be illustratively introduced below.

In some examples, as shown in FIG. 19, one terminal of the current adjustment circuit 80 is connected to the output terminal of the laser unit control circuit 30 and the input terminal of the laser unit 40, and the other terminal of the current adjustment circuit 80 is connected to the output terminal of the laser unit 40. The current adjustment circuit 80 is configured to control the current flowing through the laser unit 40 to be less than the initial power supply current when the initial power supply current is greater than the reference current.

The current adjustment circuit 80 is connected in parallel to the laser unit 40. The current flowing through the laser unit 40 is a difference between the initial power supply current and the current flowing through the current adjustment circuit 80. When the initial power supply current is less than the reference current, the current flowing through the laser unit 40 may be reduced by adjusting the current flowing through the current adjustment circuit 80, which is regarded as shunt processing of the initial power supply current. After the shunt processing is performed, the current flowing through the laser unit 40 is less than the initial power supply current, such that the ripples in the current flowing through the laser unit 40 may be reduced. Certainly, when the initial power supply current is not greater than the reference current, the shunt processing is not performed.

As shown in FIG. 20, the initial power supply current I_{supply} is the sum of the reference current I_{reference} and the ripple signal Iᵣᵢₚₚₗₑ, i.e. I_{supply}−I_{reference}+Iᵣᵢₚₚₗₑ. The reference current I_{reference} may be regarded as a direct current in the initial power supply current. The reference current I_{reference} is set on the basis of the current light source driving signal. When I_{supply}>I_{reference}, the shunt processing is performed to obtain the current Iₗₐₛₑᵣ=I_{supply}−Iₛₕᵤₙₜ flowing through the laser unit 40, where Iₛₕᵤₙₜ is not greater than Iᵣᵢₚₚₗₑ In FIG. 20, Iₛₕᵤₙₜ=Iᵣᵢₚₚₗₑ is taken as an example. It thus may be known that on the basis of this example, the ripples of the initial power supply current which supplies power to the laser unit 40 can be reduced.

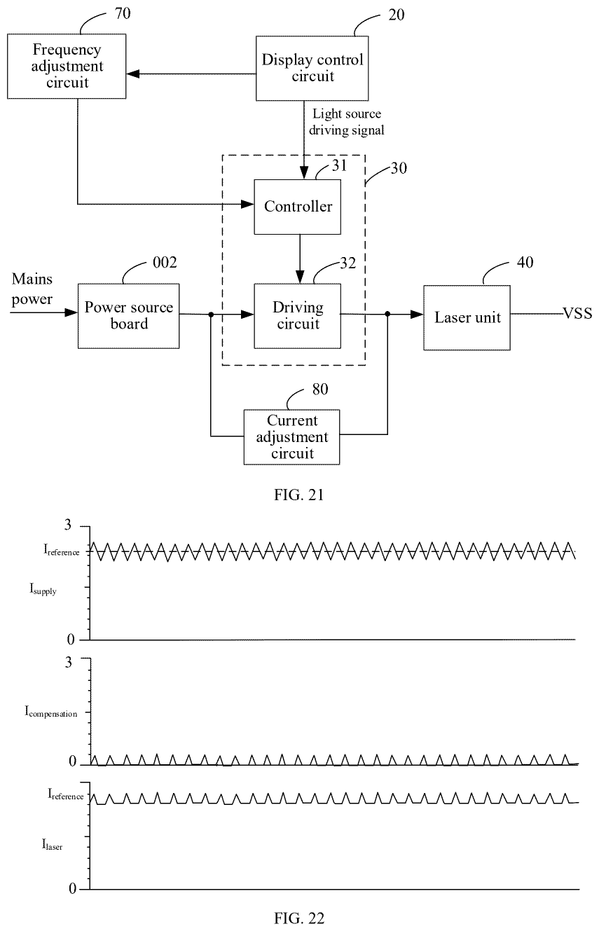

In some other examples, as shown in FIG. 21, one terminal of the current adjustment circuit 80 is connected to the output terminal of the power source board 002 and the input terminal of the laser unit control circuit 30, and the other terminal of the current adjustment circuit 80 is connected to the output terminal of the laser unit control circuit 30 and the input terminal of the laser unit 40. The current adjustment circuit 80 is configured to control the current flowing through the laser unit 40 to be greater than the initial power supply current when the initial power supply current is less than the reference current.

The current adjustment circuit 80 is connected in parallel to the laser unit control circuit 30, and the current flowing through the laser unit 40 is the sum of the current flowing through the current adjustment circuit 80 and the initial power supply current. When the initial power supply current is greater than the reference current, the current flowing through the laser unit 40 may be improved by adjusting the current flowing through the current adjustment circuit 80, which is regarded as compensation processing of the initial power supply current. After the compensation processing is performed, the current flowing through the laser unit 40 is greater than the initial power supply current, such that the ripples in the current flowing through the laser unit 40 may be eliminated. When the initial power supply current is not less than the reference current, the compensation processing is not performed.

As shown in FIG. 22, the initial power supply current I_{supply} is the sum of the reference current I_{reference} and the ripple signal Iᵣᵢₚₚₗₑ, i.e. I_{supply}=I_{reference}+Iᵣᵢₚₚₗₑ. The reference current I_{reference} may be regarded as a direct current in the initial power supply current. The reference current I_{Preset} is set on the basis of the current light source driving signal. When I_{supply}<I_{reference}, the compensation processing is performed to obtain the current Iₗₐₛₑᵣ=I_{supply}+I_{compensation} flowing through the laser unit 40, where I_{compensation} is not greater than −Iᵣᵢₚₚₗₑ. In FIG. 22, I_{compensation}−Iᵣᵢₚₚₗₑ is taken as an example. It thus may be known that on the basis of this example, the ripples of the initial power supply current which supplies power to the laser unit 40 can be eliminated.

In some other examples, the above two embodiments may be combined, i.e., two current adjustment circuits 80 are disposed in the laser unit control circuits 30, where the first current adjustment circuit 80 is connected in parallel to the laser unit 40 and the second current adjustment circuit 80 is connected in parallel to the laser unit control circuits 30. When the initial power supply current is greater than the reference current, the first current adjustment circuit 80 performs the shunt processing to control the current flowing through the laser unit 40 to be less than the initial power supply current; and when the initial power supply current is less than the reference current, the second current adjustment circuit 80 performs the compensation processing to control the current flowing through the laser unit 40 to be greater than the initial power supply current.

The current adjustment circuits 80 in the embodiments where the shunt processing and compensation processing are performed are illustratively described below.

First, the current adjustment circuit 80 that performs the shunt processing is illustratively described.

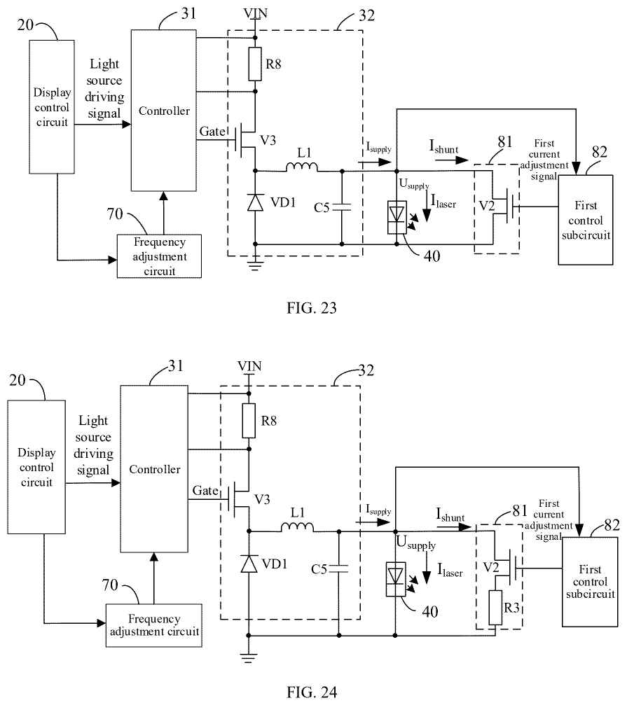

As shown in FIG. 23, the current adjustment circuit 80 includes a first control subcircuit 82 and a first current-control subcircuit 81. The first control subcircuit 82 is connected to the input terminal of the laser unit 40. The first control subcircuit 82 is configured to output a first current adjustment signal in a first state when the initial power supply current of the input terminal of the laser unit 40 is greater than the reference current and output a first current adjustment signal in a second state when the initial power supply current is not greater than the reference current when the initial power supply current is not greater than the reference current. The first current-control subcircuit 81 includes a second switching tube V2, one terminal of the second switching tube V2 is connected to the output terminal of the laser unit control circuits 30 and the input terminal of the laser unit 40, the other terminal of the second switching tube V2 is connected to the output terminal of the laser unit 40, and the control terminal of the second switching tube V2 is connected to the first control subcircuit 82. The first current-control subcircuit 81 is configured to, on the basis of the first current adjustment signal in the first state, control a current flowing through the second switching tube V2, and on the basis of the first current adjustment signal in the second state, turn off the second switching tube V2.

The first control subcircuit may also be known as a first control subunit, and the first current-control subcircuit may also be known as a first current-control subunit. The second switching tube V2 is a transistor with turning on-off and amplifying functions, which is specifically a P-type or N-type MOS field-effect transistor or a triode. By taking the second switching tube V2, which is the MOS field-effect transistor as an example, the control terminal of the second switching tube V2 corresponds to a gate of the MOS field-effect transistor.

During operation, the first control subcircuit 82 outputs the first current adjustment signal in the first state when the initial power supply current of the input terminal of the laser unit 40 is greater than the reference current. The first current adjustment signal in the first state is a signal that can turn on the second switching tube V2, and the first current adjustment signal in the first state varies with the initial power supply current to control the current flowing through the second switching tube V2. When the initial power supply current is not greater than the reference current, the first control subcircuit 82 outputs the first current adjustment signal in the second state, the first current adjustment signal in the second state is lower than turn-on voltage of the second switching tube V2, the second switching tube V2 is turned off, and the current adjustment circuit 80 does not share the current.

In some examples, as shown in FIG. 24, the first current-control subcircuit 81 includes a third resistor R3. One terminal of the third resistor R3 is connected to one terminal of the second switching tube V2, and the other terminal of the third resistor R3 is connected to the output terminal of the laser unit 40.

The third resistor R3 is a voltage-divider resistor, which can prevent the operating circuit of the second switching tube V2 from being short-circuited when the second switching tube V2 operates in a saturated state. In addition, the relationship between the shunt current Iₛₕᵤₙₜ and Iᵣᵢₚₚₗₑ of the current adjustment circuit 80 may also be set through the resistance value of the third resistor R3, which will be specifically described in the subsequent examples.

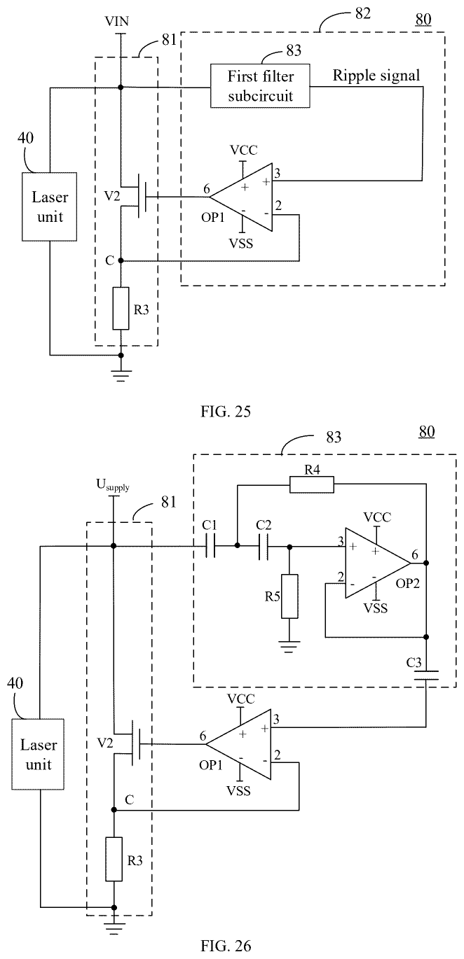

In an example, as shown in FIG. 25, the first control subcircuit 82 includes a first filter subcircuit 83 and a first operational amplifier OP1. An input terminal of the first filter subcircuit 83 is connected to the input terminal of the laser unit 40, and the first filter subcircuit 83 is configured to filter out a reference voltage corresponding to the direct current reference current in a power supply voltage at the input terminal of the laser unit 40. A non-inverting input terminal of the first operational amplifier OP1 is connected to an output terminal of the first filter subcircuit 83, an inverting input terminal of the first operational amplifier OP1 is connected to one terminal of the third resistor R3, and an output terminal of the first operational amplifier OP1 is connected to a control terminal of the second switching tube V2. The first filter subcircuit may also become a first filter subunit.

It is to be noted that on the basis of Ohm's Law, under a condition of a certain load, the voltage is in direct proportion to the current. It may be understood that the reference voltage corresponding to the reference current under the current light source driving signal is an ideal voltage of the input terminal of the laser unit 40. The initial power supply current is generated on the basis of the voltage of the output terminal (i.e., the input terminal of the laser unit) of the driving circuit 32. When the initial power supply current is greater than the reference current, the power supply voltage (abbreviated as the power supply voltage below) of the input terminal of the laser unit 40 is also greater than the reference voltage. Therefore, the magnitude relationship between the initial power supply current and the reference current may be determined by determining the magnitude relationship between the power supply voltage and the reference voltage.

The first filter subcircuit 83 serves as a filter. The specific first filter subcircuit 83 is an active filter or a reactive filter, a low-order filter or a high-order filter, which is not limited in this example.

This example will be illustratively described below in conjunction with practical scenarios. The first filter subcircuit 83 outputs an alternating ripple voltage Uᵣᵢₚₚₗₑ=U_{supply}−U_{reference}. It may be understood that when the power supply voltage U_{supply} corresponding to the initial power supply current I_{supply} is greater than the reference voltage U_{reference} corresponding to the reference current I_{reference}, the ripple voltage Uᵣᵢₚₚₗₑ is greater than zero; otherwise, the ripple voltage Uᵣᵢₚₚₗₑ is not greater than zero.

Continuously referring to FIG. 25, the non-inverting input terminal of the first operational amplifier OP1 receives the alternating ripple voltage Uᵣᵢₚₚₗₑ. The inverting input terminal of the first operational amplifier OP1 is connected to the other terminal of the second switching tube V2. It may be known on the basis of the virtual short principle that the voltage of the non-inverting input terminal of the first operational amplifier OP1 is equal to that of the inverting input terminal. Therefore, the voltage U3 of the non-inverting input terminal is also equal to the voltage UC of a point C at the other terminal of the second switching tube V2. U3 varies along with the ripple voltage. To make U3=UC, the first operational amplifier OP1 needs to output the corresponding first current adjustment signal in the first state based on the ripple signal to adjust the opening degree of the second switching tube V2, so as to control the current flowing through the second switching tube V2. When the ripple voltage Uᵣᵢₚₚₗₑ is not greater than zero, the corresponding UC is not greater than zero, too. UC cannot be a negative value. When the ripple voltage Uᵣᵢₚₚₗₑ is not greater than zero, the first operational amplifier OP1 outputs the first current adjustment signal in the second state, which controls the second switching tube V2 to be turned off. Therefore, on the basis of this example, when the initial power supply current is greater than the reference current, the shunt processing can be performed, and when the initial power supply current is not greater than the reference current, the shunt processing is not performed.

In addition, on the basis of Ohm's law, UC=Iₛₕᵤₙₜ(t)·R3. It may be known that the corresponding relationship between Iₛₕᵤₙₜ(t) and Iᵣᵢₚₚₗₑ(t) may be set on the basis of R3, which may specifically be as follows:

$${I}_{shunt} ( t ) = α {I}_{ripple} ( t ) ( 0 \leq α \leq 1 ) ;$$

$${I}_{supply} = {I}_{laser} + {I}_{shunt} ( t ) ;$$

$${I}_{supply} = {I}_{reference} + {I}_{ripple} ( t ) ;$$

$${I}_{laser} = {I}_{reference} + ( 1 - α ) {I}_{ripple} ( t ) ( 0 \leq α \leq 1 ) ;$$

where the value of α may be adjusted through the resistance value of the third resistor R3.

In this example, the first operational amplifier OP1, the third resistor R3, and the second switching tube V2 form a voltage-control current source, i.e., on the basis of the voltage of the non-inverting terminal of the first operational amplifier OP1, the current flowing through the second switching tube V2 is controlled, and the voltage of the non-inverting input terminal of the first operational amplifier OP1 is also generated on the basis of the ripple voltage outputted by the first filter subcircuit 83. Therefore, the current of the second switching tube V2 may be controlled on the basis of the ripple voltage. In addition, the proportion of ripple reduction may be adjusted through the resistance value of the third resistor R3.

In some examples, as shown in FIG. 26, the first filter subcircuit 83 further includes a first capacitor C1, a second capacitor C2, a second operational amplifier OP2, a fourth resistor R4, and a fifth resistor R5. One terminal of the first capacitor C1 is connected to the input terminal of the laser unit 40, and the other terminal of the first capacitor C1 is connected to one terminal of the second capacitor C2. The other terminal of the second capacitor C2 is connected to the non-inverting input terminal of the second operational amplifier OP2. A non-inverting input terminal of the second operational amplifier OP2 is connected to the output terminal of the second operational amplifier OP2, and an output terminal of the second operational amplifier OP2 is connected to the non-inverting input terminal of the first operational amplifier OP1. One terminal of the fourth resistor R4 is connected to the other terminal of the first capacitor C1 and one terminal of the second capacitor C2, and the other terminal of the fourth resistor R4 is connected to the output terminal of the second operational amplifier OP2. One terminal of the fifth resistor R5 is connected to the other terminal of the second capacitor C2, and the other terminal of the fifth resistor R5 is connected to the ground.

The first filter subcircuit 83 is an active second-order high-pass filter. The first capacitor C1 and the fourth resistor R4 form a first-order RC filter. The second capacitor C2 and the fifth resistor R5 form a second-order RC filter. The RC filter filters out the direct current voltage (reference voltage) in the power supply voltage by means of an AC-passing and DC-blocking characteristic of the capacitor to obtain the alternating ripple voltage. The two RC filters can improve the filter effect of the first filter subcircuit 83. In this implementation, the second operational amplifier OP2 is also disposed, such that the first control subcircuit 82 is the active filter, which can further improve the filter effect.

On the basis of the above implementation, continuously referring to FIG. 26, the first filter subcircuit 83 further includes a third capacitor C3, where one terminal of the third capacitor C3 is connected to the output terminal of the second operational amplifier OP2, and the other terminal of the third capacitor C3 is connected to the non-inverting input terminal of the first operational amplifier OP1. The third capacitor C3 is configured to further filter out the direct current voltage in the ripple voltage, so as to improve the filter effect of the first filter subcircuit 83.

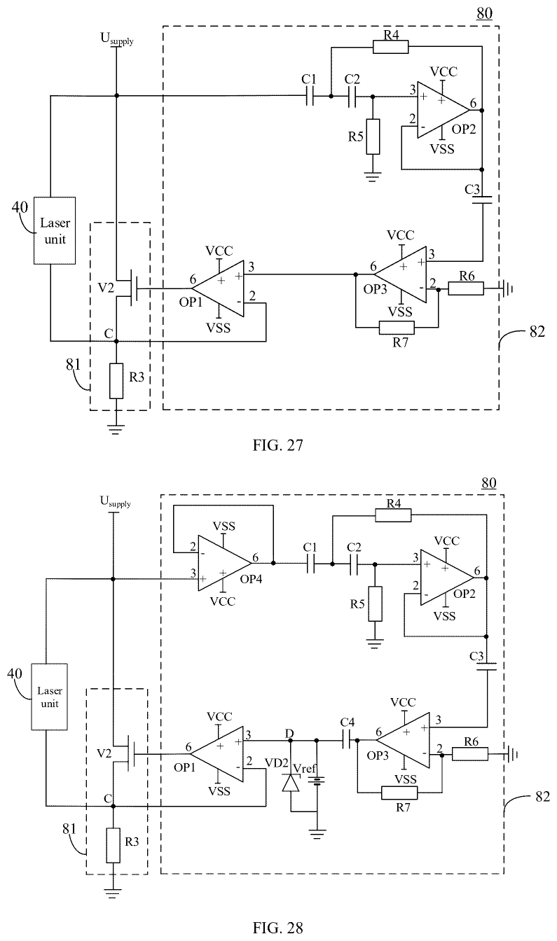

In some examples, as shown in FIG. 27, the first control subcircuit 82 further includes a third operational amplifier OP3, a sixth resistor R6, and a seventh resistor R7. Anon-inverting input terminal of the third operational amplifier OP3 is connected to an output terminal of the second operational amplifier OP2, an inverting input terminal of the third operational amplifier OP3 is connected to one terminal of the sixth resistor R6, and an output terminal of the third operational amplifier OP3 is connected to the non-inverting input terminal of the first operational amplifier OP1. The other terminal of the sixth resistor R6 is connected to the ground. One terminal of the seventh resistor R7 is connected to the output terminal of the third operational amplifier OP3, and the other terminal of the seventh resistor R7 is connected to the inverting input terminal of the third operational amplifier OP3 and one terminal of the sixth resistor R6.

It may be known from the above examples that the direct current reference voltage is filtered from the power supply voltage U to obtain the alternating ripple voltage, and the ripple voltage is relatively less. In this example, the ripple voltage is amplified, such that the first operational amplifier OP1 outputs the more accurate first current adjustment signal, thereby improving the current-control precision of the current adjustment circuit 80.

The voltage Uo of the output terminal of the third operational amplifier OP3 is =A(U_{P}−U_{N}), where A is an amplification factor, U_{P} is the voltage of the non-inverting input terminal of the third operational amplifier OP3, and U_{N} is the voltage of the inverting input terminal. It may be known from the circuit structure of this example that A=(R6+R7)/R6.

In some examples, as shown in FIG. 28, the first control subcircuit 82 further includes a fourth capacitor C4, where one terminal of the fourth capacitor C4 is connected to the output terminal of the third operational amplifier OP3, and the other terminal of the fourth capacitor C4 is connected to the non-inverting input terminal of the first operational amplifier OP1. The fourth capacitor C4 is configured to further filter out the direct current voltage in the amplified ripple voltage.

In some examples, continuously referring to FIG. 28, the first control subcircuit 82 further includes a fourth operational amplifier OP4. A non-inverting input terminal of the fourth operational amplifier OP4 is connected to the input terminal of the laser unit 40, the inverting input terminal of the fourth operational amplifier OP4 is connected to the output terminal of the fourth operational amplifier OP4, and the output terminal of the fourth operational amplifier OP4 is connected to the input terminal of the first filter subcircuit 83.

The non-inverting input terminal of the fourth operational amplifier OP4 is connected to the input terminal of the laser unit 40 to receive the power supply voltage U_{supply}, and the inverting input terminal thereof is connected to the output terminal. On the basis of the virtual short principle of the operational amplifier, the voltage of the non-inverting input terminal is equal to that of the inverting input terminal. Therefore, the voltage of the output terminal of the fourth operational amplifier OP4 is the power supply voltage U_{supply}, that is, the fourth operational amplifier OP4 is a voltage follower. The voltage follower has the characteristic of inputting high impedance and outputting low impedance, and may play an impedance matching role in the circuit, such that the next stage amplification circuit operates better.

In some examples, as shown in FIG. 28, the first control subcircuit 82 further includes a voltage-stabilizing diode VD2. An anode of the voltage-stabilizing diode VD2 is connected to the ground, and a cathode of the voltage-stabilizing diode VD2 is connected to the non-inverting input terminal of the first operational amplifier OP1.

The voltage-stabilizing diode VD2 plays a limiting role to limit the voltage value outputted to the first operational amplifier OP1. When the voltage of a point D is less than a stable voltage of the voltage-stabilizing diode VD2, the voltage is inputted to the first operational amplifier OP1. When the voltage is greater than the stable voltage of the voltage-stabilizing diode VD2, the voltage of the point D is maintained at the stable voltage. The stable voltage is inputted to the first operational amplifier OP1, to prevent the first operational amplifier OP1 accessing an excessively high voltage from being damaged.

In some examples, as shown in FIG. 28, the first control subcircuit 82 further includes a bias current source. An anode of the bias current source is connected to the cathode of the voltage-stabilizing diode VD2, and a cathode of the bias current source is connected to the anode of the voltage-stabilizing diode VD2 and is connected to the ground.

In this example, the current flowing through the laser unit 40 is as follows:

$${I}_{shunt} ( t ) = {I}_{bias} + α {I}_{ripple} ( t ) ( 0 \leq α \leq 1 ) ;$$

$${I}_{supply} = {I}_{reference} + {I}_{shunt} ( t ) ;$$

$${I}_{laser} = {I}_{reference} - {I}_{bias} + ( 1 - α ) {I}_{ripple} ( t ) ( 0 \leq α \leq 1 ) ;$$

Therefore, the shunt effect on the initial power supply current may be further improved.

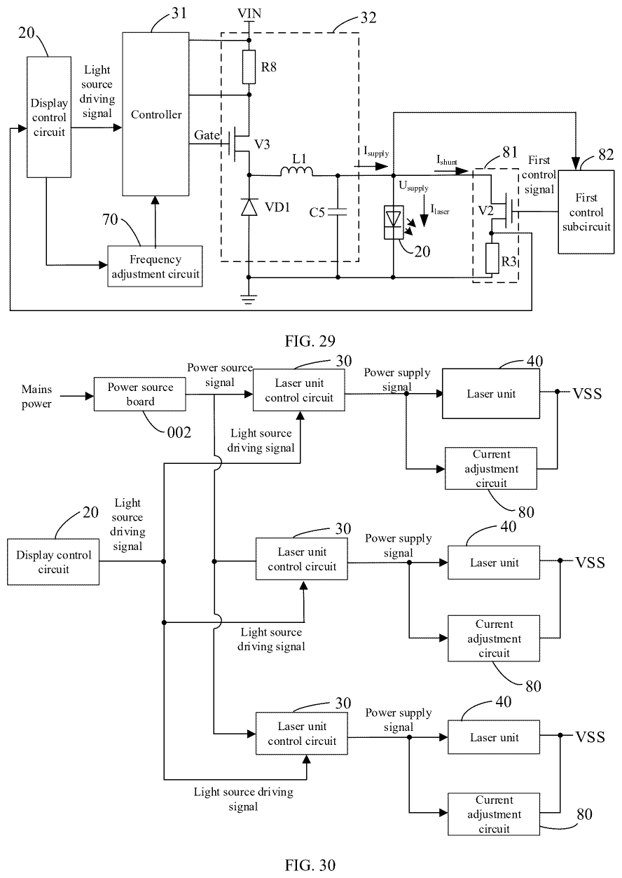

In some examples, as shown in FIG. 29, the display control circuit 20 is further connected to the laser unit control circuit 30, and the display control circuit 20 is configured to, on the basis of the current flowing through the second switching tube V2, adjust the light source driving signal, so as to increase the reference current.

In the above example, when the initial power supply current is greater than the reference current, the shunt processing is performed, which will reduce the valid current signal flowing through the laser unit 40, resulting in insufficient brightness of the laser unit 40. In this example, the display control circuit 20 is connected to the current adjustment circuit 80. Specifically, as shown in FIG. 29, the display control circuit may be connected to one terminal of the third resistor R3 to sample the current signal flowing through the second switching tube V2 and increase the corresponding light source driving signal on the basis of the current signal, which may increase the reference current of the laser unit control circuit 30 and further increase the direct current power supply voltage outputted by the laser unit control circuit 30, thereby improving the brightness of the laser unit 40.

It is to be noted that in some examples, as shown in FIG. 30, there are a plurality of laser units 40. The laser projection apparatus includes a plurality of laser unit control circuits 30 and a plurality of current adjustment circuits 80. The plurality of laser units 40, the plurality of laser unit control circuits 30, and the plurality of current adjustment circuits 80 correspond on a one-to-one basis. For each laser unit control circuit 30, the laser unit control circuit 30 receives the power source signal and the light source driving signal and is connected to the input terminal of the corresponding laser unit 40 and the input terminal of the corresponding current adjustment circuit 80. The output terminal of each laser unit 40 is connected to the output terminal of the corresponding current adjustment circuit 80 and is connected to the ground.

The current adjustment circuit 80 that performs the shunt processing is illustratively described above, and the current adjustment circuit 80 that performs the compensation processing will be illustratively described below.

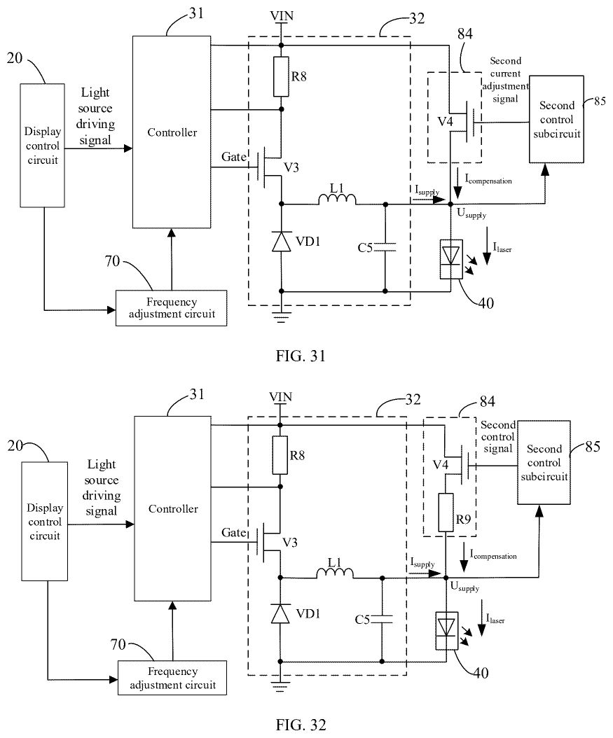

As shown in FIG. 31, the current adjustment circuit 80 includes a second control subcircuit 85 and a second current-control subcircuit 84. The second control subcircuit 85 is connected to the input terminal of the laser unit 40, and the second control subcircuit 85 is configured to output a second current adjustment signal in a first state when the initial power supply current is less than the reference current and output a second current adjustment signal in a second state when the initial power supply current is not less than the reference current. The second current-control subcircuit 84 includes a fourth switching tube V4, where one terminal of the fourth switching tube V4 is connected to the output terminal of the power source board 002, and the other terminal of the fourth switching tube V4 is connected to the output terminal of the laser unit control circuit 30 and the input terminal of the laser unit 40. The second current-control subcircuit 84 is configured to, on the basis of the second current adjustment signal in the first state, control a current flowing through the fourth switching tube V4, and on the basis of the second current adjustment signal in the second state, turn off the fourth switching tube V4.

The second control subcircuit may also be known as a second control subunit, and the second current-control subcircuit may also be known as a second current-control subunit. The fourth switching tube V4 is a transistor with turning on-off and amplifying functions, which is specifically a P-type or N-type MOS field-effect transistor or a triode. By taking the fourth switching tube, V4 which is the MOS field-effect transistor as an example, the control terminal of the fourth switching tube V4 corresponds to a gate of the MOS field-effect transistor.

During operation, the second control subcircuit 85 outputs the second current adjustment signal in the first state when the initial power supply current of the input terminal of the laser unit 40 is less than the reference current. The second current adjustment signal in the first state is a signal that can turn on the fourth switching tube V4, and the second current adjustment signal in the first state varies with the initial power supply current to control the current flowing through the fourth switching tube V4. When the initial power supply current is not less than the reference current, the second current adjustment signal in the second state is outputted, the second current adjustment signal in the second state is lower than turn-on voltage of the fourth switching tube V4, the fourth switching tube V4 is turned off, and the current adjustment circuit 80 does not compensate the current.

In some examples, as shown in FIG. 32, the second current-control subcircuit 84 further includes a ninth resistor R9. One terminal of the ninth resistor R9 is connected to the other terminal of the fourth switching tube V4, and the other terminal of the ninth resistor R9 is connected to the input terminal of the laser unit 40 and the output terminal of the laser unit control circuit 30.

The ninth resistor R9 is a voltage-divider resistor, which can prevent the operating circuit of the fourth switching tube V4 from being short-circuited when the fourth switching tube V4 operates in a saturated state. In addition, the relationship between the shunt current I_{compensation} and Iᵣᵢₚₚₗₑ of the current adjustment circuit 80 may also be set through the resistance value of the ninth resistor R9, which will be specifically described in the subsequent examples.

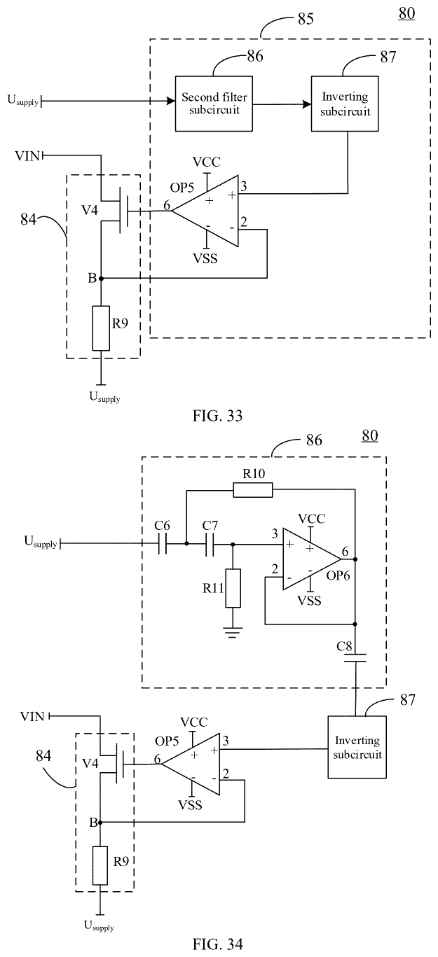

In some examples, as shown in FIG. 33, the second control subcircuit 85 includes a second filter subcircuit 86, an inverting subcircuit 87, and a fifth operational amplifier OP5. The second filter subcircuit 86 is connected to the input terminal of the laser unit 40. The second filter subcircuit 86 is configured to filter out a reference voltage corresponding to the reference current in a power supply voltage at the input terminal of the laser unit 40 and output the filtered power supply voltage. The inverting subcircuit 87 is connected to an output terminal of the second filter subcircuit 86, and the inverting subcircuit 87 is configured to output the inverted filtered power supply voltage. A non-inverting input terminal of the fifth operational amplifier OP5 is connected to an output terminal of the inverting subcircuit 87, an inverting input terminal of the fifth operational amplifier OP5 is connected to one terminal of the ninth resistor R9 and the other terminal of the fourth switching tube V4, and an output terminal of the fifth operational amplifier OP5 is connected to a control terminal of the fourth switching tube V4. The second filter subcircuit may also be known as a second filter subunit, and the inverting subcircuit may also be known as an inverting subunit.

It is to be noted that on the basis of Ohm's Law, under a condition of a certain load, the voltage is in direct proportion to the current. It may be understood that the reference voltage corresponding to the reference current under the current light source driving signal is an ideal voltage of the input terminal of the laser unit 40. The initial power supply current is generated on the basis of the actual voltage of the output terminal (i.e., the input terminal of the laser unit 40) of the laser unit control circuit 30. When the initial power supply current is greater than the reference current, the power supply voltage (abbreviated as the power supply voltage below) of the input terminal of the laser unit 40 is also greater than the reference voltage. Therefore, the magnitude relationship between the initial power supply current and the reference current may be determined by determining the magnitude relationship between the power supply voltage and the reference voltage.

The second filter subcircuit 86 is a filter. The specific second filter subcircuit 86 is an active filter or a reactive filter, a low-order filter or a high-order filter, which is not limited in this example.

This example will be illustratively described below in conjunction with practical scenarios: the second filter subcircuit 86 outputs an alternating ripple voltage Uᵣᵢₚₚₗₑ=U_{supply}−U_{reference}. It may be understood that when the power supply voltage U_{supply} corresponding to the initial power supply current I_{supply} is less than the reference voltage U_{reference} corresponding to the reference current I_{reference}, the ripple voltage Uᵣᵢₚₚₗₑ is less than zero; otherwise, the ripple voltage Uᵣᵢₚₚₗₑ is not less than zero.

Continuously referring to FIG. 33, the inverting subcircuit 87 will receive the alternating ripple voltage Uᵣᵢₚₚₗₑ. The inverting subcircuit 87 converts the ripple voltage Uᵣᵢₚₚₗₑ into an inverting ripple voltage −Uᵣᵢₚₚₗₑ, the non-inverting input terminal of the fifth operational amplifier OP5 receives the inverting ripple voltage −Uᵣᵢₚₚₗₑ, and the inverting input terminal of the fifth operational amplifier OP5 is connected to the other terminal of the fourth switching tube V4. It may be known on the basis of the virtual short principle of the operational amplifier that the voltage of the non-inverting input terminal of the fifth operational amplifier OP5 is equal to that of the inverting input terminal. Therefore, the voltage U3 of the non-inverting input terminal is also equal to the voltage UB of a point B of the other terminal of the fourth switching tube V4. U3 varies along with the ripple signal. To make U3=UB, the fifth operational amplifier OP5 needs to output the corresponding second current adjustment signal based on the ripple signal to adjust the opening degree of the fourth switching tube V4, so as to control the current flowing through the fourth switching tube V4. When the ripple voltage Uᵣᵢₚₚₗₑ is less than zero, the inverting ripple voltage −Uᵣᵢₚₚₗₑ is greater than zero, U3 is greater than zero, so the fifth operational amplifier OP5 outputs the second current adjustment signal in the first state to make U3=UB; and when the ripple voltage Uᵣᵢₚₚₗₑ is not less than zero, the inverting ripple voltage −Uᵣᵢₚₚₗₑ is less than zero, U3 is less than zero, so the fifth operational amplifier OP5 outputs the second current adjustment signal in the second state that controls the fourth switching tube V4 to be turned off. Therefore, on the basis of this example, when the initial power supply current is less than the reference current, the compensation processing is performed, and when the initial power supply current is not less than the reference current, the compensation processing is not performed.

In addition, on the basis of Ohm's law, UB=I_{compensation}(t)·R9. It may be known that the corresponding relationship between I_{compensation}(t) and Iᵣᵢₚₚₗₑ(t) may be set on the basis of R9, which may specifically be as follows:

$${I}_{compensation} ( t ) = - α {I}_{ripple} ( t ) ( 0 \leq α \leq 1 ) ;$$

$${I}_{laser} = {I}_{supply} + {I}_{compensation} ( t ) ;$$

$${I}_{supply} = {I}_{reference} + {I}_{ripple} ( t ) ;$$

$${I}_{laser} = {I}_{reference} + ( 1 - α ) {I}_{ripple} ( t ) ( 0 \leq α \leq 1 ) ;$$

where the value of a may be adjusted through the resistance value of the ninth resistor R9.

In some examples, as shown in FIG. 34, the second filter subcircuit 86 further includes a sixth capacitor C6, a seventh capacitor C7, a sixth operational amplifier OP6, a tenth resistor R10, and an eleventh resistor R11. One terminal of the sixth capacitor C6 is connected to the input terminal of the laser unit 40, the other terminal of the sixth capacitor C6 is connected to one terminal of the seventh capacitor C7, and the other terminal of the seventh capacitor C7 is connected to the output terminal of the sixth operational amplifier OP6. An inverting input terminal of the sixth operational amplifier OP6 is connected to the output terminal of the sixth operational amplifier OP6, and the output terminal of the sixth operational amplifier OP6 is connected to the inverting subcircuit 87. One terminal of the tenth resistor R10 is connected to the other terminal of the sixth capacitor C6 and one terminal of the seventh capacitor C7, and the other terminal of the tenth resistor R10 is connected to the output terminal of the sixth operational amplifier OP6. One terminal of the eleventh resistor R11 is connected to the other terminal of the seventh capacitor C7, and the other terminal of the eleventh resistor R11 is connected to the ground.

The operating principle of the second filter subcircuit 86 is the same as that of the first filter subcircuit 83 and may specifically refer to the related content of the above first filter subcircuit 83, which is not repeatedly described herein.

In some examples, as shown in FIG. 34, the second filter subcircuit 86 further includes an eighth capacitor C8, where one terminal of the eighth capacitor C8 is connected to the output terminal of the sixth operational amplifier OP6, and the other terminal of the eighth capacitor C8 is connected to the non-inverting input terminal of the fifth operational amplifier OP5. The eighth capacitor C8 is configured to further filter out the direct current signal in the ripple voltage signal, so as to improve the filter effect of the second filter subcircuit 86.

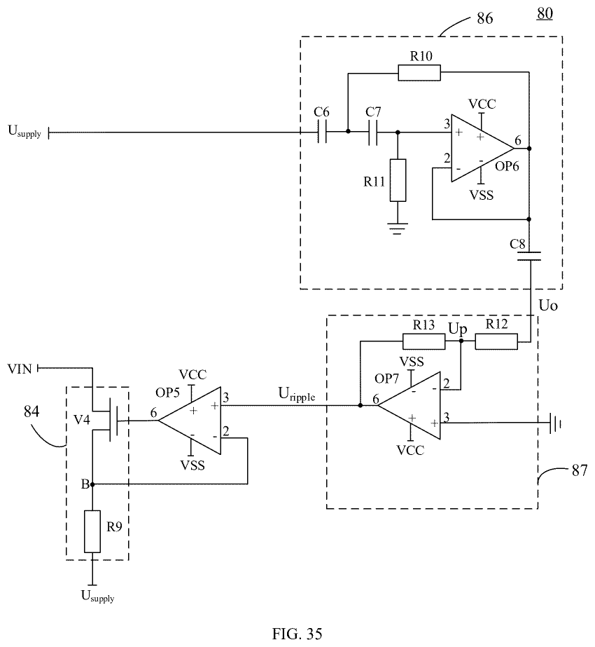

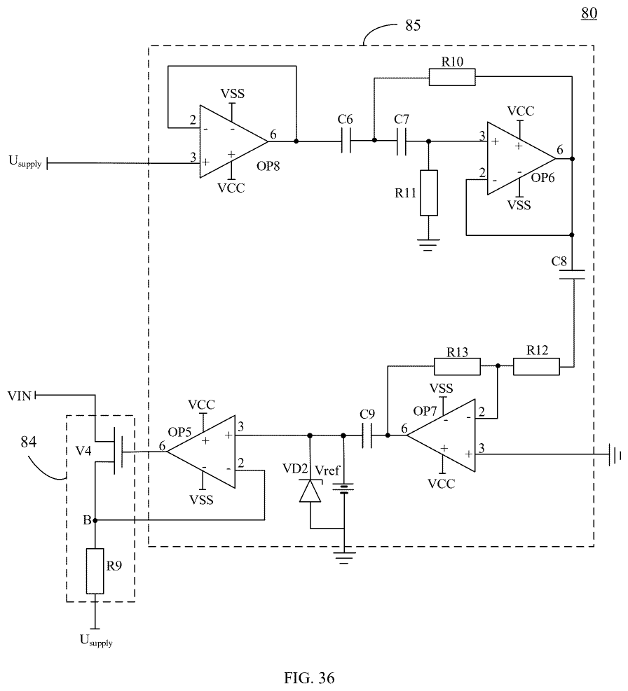

In some examples, as shown in FIG. 35, the inverting subcircuit 87 includes a seventh operational amplifier OP7, a twelfth resistor R12, and a thirteenth resistor R13. One terminal of the twelfth resistor R12 is connected to the second filter subcircuit 86, and the other terminal of the twelfth resistor R12 is connected to the inverting input terminal of the seventh operational amplifier OP7. A non-inverting input terminal of the seventh operational amplifier OP7 is connected to the ground, and an output terminal of the seventh operational amplifier OP7 is connected to the non-inverting input terminal of the fifth operational amplifier OP5. One terminal of the thirteenth resistor R13 is connected to the other terminal of the twelfth resistor R12 and the inverting input terminal of the seventh operational amplifier OP7, and the other terminal of the thirteenth resistor R13 is connected to the output terminal of the seventh operational amplifier OP7.

The seventh operational amplifier OP7 is an inverting operational amplifier. Since the current does not flow through the operational amplifier, the current flowing through the twelfth resistor R12 and the thirteenth resistor R13 may be obtained:

$$I = ( {U}_{ripple} - {U}_{P} ) / R 12 = ( {U}_{P} - U o ) / R 13$$

On the basis of the virtual short principle, U_{P}=0, so o=−Uᵣᵢₚₚₗₑ R13/R12. Therefore, on the basis of this example, the inverting ripple signal may be outputted.

In addition, the amplification factor may also be adjusted on the basis of the twelfth resistor R12 and the thirteenth resistor R13, the amplification factor is A=R13/R12. When R13 is set to be greater than R12, Uo may be amplified. After the direct current reference current is filtered out from the initial power supply current, the alternating ripple signal is obtained, and the ripple signal is relatively small. In this example, the ripple signal is amplified, such that the fifth operational amplifier OP5 outputs the more accurate second current adjustment signal, thereby improving the current-control precision of the current adjustment circuit 80.

In some examples, as shown in FIG. 36, the second control subcircuit 85 further includes a ninth capacitor C9, where one terminal of the ninth capacitor C9 is connected to the output terminal of the seventh operational amplifier OP7, and the other terminal of the ninth capacitor C9 is connected to the non-inverting input terminal of the fifth operational amplifier OP5. The ninth capacitor C9 is configured to further filter out the direct current signal in the amplified ripple signal.

In some examples, as shown in FIG. 36, the second control subcircuit 85 further includes an eighth operational amplifier OP8, where a non-inverting input terminal of the eighth operational amplifier OP8 is connected to the input terminal of the laser unit 40, an inverting input terminal of the eighth operational amplifier OP8 is connected to the output terminal of the eighth operational amplifier OP8, and the output terminal of the eighth operational amplifier OP8 is connected to one terminal of the sixth capacitor C6.

The operating principle of the eighth operational amplifier OP8 is similar to that of the fourth operational amplifier OP4 and may specifically refer to the related description of the fourth operational amplifier OP4, which is not repeatedly described herein.

In some examples, as shown in FIG. 36, the second control subcircuit 85 further includes a voltage-stabilizing diode VD2 and a bias current source. An anode of the voltage-stabilizing diode VD2 is connected to the ground, and a cathode of the voltage-stabilizing diode VD2 is connected to the non-inverting input terminal of the fifth operational amplifier OP5. An anode of the bias current source is connected to the cathode of the voltage-stabilizing diode VD2, and a cathode of the bias current source is connected to the anode of the voltage-stabilizing diode VD2 and is connected to the ground.

The operating principles of the voltage-stabilizing diode VD2 and the bias current source may refer to the related content in the above first control subcircuit 82, which is not repeatedly described herein.

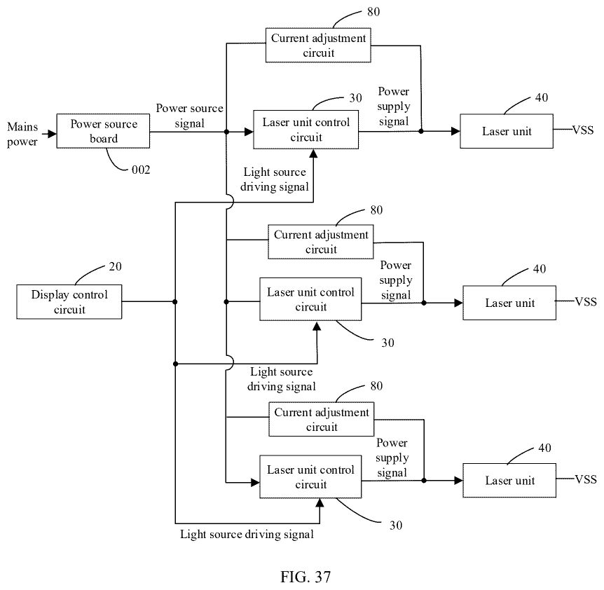

It is to be noted that in some examples, as shown in FIG. 37, there are a plurality of laser units 40. The laser projection apparatus includes a plurality of laser unit control circuits 30 and a plurality of current adjustment circuits 80. The plurality of laser units 40, the plurality of laser unit control circuits 30, and the plurality of current adjustment circuits 80 correspond on a one-to-one basis.

For each current adjustment circuit 80, one terminal of the current adjustment circuit 80 is connected to the output terminal of the corresponding laser unit control circuit 30 and the output terminal of the power source board 002, and the other terminal of the current adjustment circuit 80 is connected to the output terminal of the corresponding laser unit control circuit 30 and the input terminal of the corresponding laser unit 40.

It is to be complementarily noted that in FIG. 19, FIG. 21, FIGS. 23-24, FIG. 29, and FIGS. 31-32, there may be one of the frequency adjustment circuit 70 and the current adjustment circuit 80.

The embodiments of the present disclosure further provide a laser unit control circuit 30. The laser unit control circuit 30 includes a controller 31 and a driving circuit 32. The controller 31 is connected to the display control circuit 20 and the driving circuit 32, the controller 31 being configured to generate, on the basis of the image enable signal and the brightness control signal, control signals. The driving circuit 32 is connected to the corresponding laser unit 40, the driving circuit 32 being configured to generate, on the basis of the control signals, a power supply signal for supplying power to the corresponding laser unit 40. The control signals include a first control signal and a second control signal. The first control signal is a constant-level signal outputted by the controller 31 when the image enable signal is converted from an invalid level to a valid level and the power supply signal does not reach a reference power supply value corresponding to the brightness control signal. The second control signal is a PWM signal outputted by the controller 31 when the image enable signal is a valid level and the power supply signal reaches the reference power supply value corresponding to the brightness control signal.

A specific content relating to the laser unit control circuit 30 may refer to the content above, which is not repeatedly described herein.

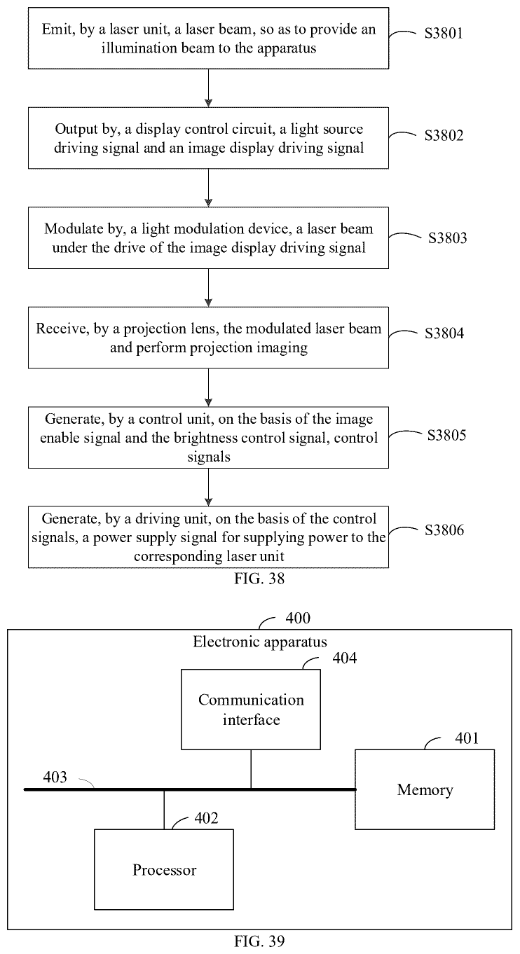

The embodiments of the present disclosure further provide a control method for a laser projection apparatus. As shown in FIG. 38, the control method for a laser projection apparatus includes the following steps:
S3801, a laser unit 40 emits a laser beam, so as to provide an illumination beam to the apparatus.
S3802, the display control circuit 20 outputs a light source driving signal and an image display driving signal. The light source driving signal includes an image enable signal and a brightness control signal.
S3803, a light modulation device 50 modulates a laser beam under the drive of the image display driving signal.
S3804, a projection lens 60 receives the modulated laser beam and performs projection imaging.
S3805, a controller 31 generates, on the basis of the image enable signal and the brightness control signal, control signals.
S3806, a driving circuit 32 generates, on the basis of the control signals, a power supply signal for supplying power to the corresponding laser unit 40.

The control signals include a first control signal and a second control signal. The first control signal is a constant-level signal outputted by the controller 31 when the image enable signal is converted from an invalid level to a valid level and the power supply signal does not reach a reference power supply value corresponding to the brightness control signal. The second control signal is a PWM signal outputted by the controller 31 when the image enable signal is a valid level and the power supply signal reaches the reference power supply value corresponding to the brightness control signal.

In some examples, S3805 includes the following steps. The frequency adjustment circuit 70 controls the controller 31 to output the control signal of the first frequency when the image enable signal is converted from the invalid level to the valid level and the power supply signal does not reach a reference power supply value corresponding to the brightness control signal. The frequency adjustment circuit 70 controls the controller 31 to output the control signal of the second frequency when the image enable signal is at the valid level and the power supply signal reaches the reference power supply value corresponding to the brightness control signal. The first frequency is less than the second frequency. the control signal of the first frequency includes a first control signal. the control signal of the second frequency is a second control signal.

A specific content relating to a control method for the laser projection apparatus may refer to the content above, which is not repeatedly described herein.

FIG. 39 is a schematic diagram of a hardware structure of an electronic apparatus provided by an embodiment of the present disclosure. As shown in FIG. 39, the electronic apparatus 400 includes a memory 401 and a processor 402. The memory 401 is configured to store a computer program. The processor 402 is configured to execute a computer program stored in the memory to implement the laser unit driving method in the above embodiments.

In some examples, the memory 401 may either be independent or integrated with the processor 402.

When the memory 401 is a device independent from the processor 402, the electronic apparatus 400 further includes a bus 403, where the bus 403 is configured to connect the memory 401 and the processor 402.

In some examples, the electronic apparatus provided by this embodiment further includes a communication interface 404, where the communication interface 404 is connected to the processor 402 through the bus 403. The processor 402 controls the communication interface 404 to implement the above receiving and transmitting functions of the electronic apparatus 400.

The embodiment of the present disclosure further provides a computer readable storage medium, the computer readable storage medium includes a computer program, and the computer program is configured to implement the control method in the above embodiments.

The above descriptions are merely exemplary embodiments of the present disclosure and are not intended to limit the present disclosure. Any modification, equivalent replacement, improvement, etc., made within the principle of the present disclosure shall be included in the protection scope of the present disclosure.

1. A laser projection apparatus, wherein the laser projection apparatus comprises a laser light source, a light modulation device, a projection lens, a display control circuit, and at least one laser unit control circuit;
the laser light source comprises at least one laser unit, which corresponds to the at least one laser unit control circuit on a one-to-one basis, the at least one laser unit being configured to emit a laser beam;
the display control circuit is configured to output a light source driving signal and an image display driving signal, the light source driving signal comprising an image enable signal and a brightness control signal;
the light modulation device is configured to modulate the laser beam under the drive of the image display driving signal; the projection lens is configured to receive the modulated laser beam and perform projection imaging;
the at least one laser unit control circuit comprises a controller and a driving circuit, the controller being connected to the display control circuit and the driving circuit, the controller being configured to generate, based on the image enable signal and the brightness control signal, control signals; the driving circuit being connected to a corresponding laser unit, the driving circuit being configured to generate, based on the control signals, a power supply signal for supplying power to the corresponding laser unit; and
wherein the control signals comprise a first control signal and a second control signal, the first control signal being a constant-level signal outputted by the controller when the image enable signal is converted from an invalid level to a valid level and the power supply signal does not reach a reference power supply value corresponding to the brightness control signal; and the second control signal being a PWM signal outputted by the controller when the image enable signal is the valid level and the power supply signal reaches the reference power supply value corresponding to the brightness control signal.

2. The laser projection apparatus according to claim 1, wherein the laser projection apparatus further comprises a frequency adjustment circuit, the frequency adjustment circuit being coupled to the controller;
the frequency adjustment circuit is configured to control the controller to output a control signal with a first frequency when the image enable signal is converted from the invalid level to the valid level and the power supply signal does not reach the reference power supply value corresponding to the brightness control signal, and the controller is controlled to output a control signal with a second frequency when the image enable signal is the valid level and the power supply signal reaches the reference power supply value corresponding to the brightness control signal; and
wherein the first frequency is less than the second frequency, the control signal of the first frequency comprising the first control signal and the control signal of the second frequency comprising the second control signal.

3. The laser projection apparatus according to claim 2, wherein the display control circuit is further connected to the frequency adjustment circuit, and the display control circuit is configured to output a first frequency adjustment signal when the image enable signal is converted from the invalid level to the valid level and the power supply signal does not reach the reference power supply value corresponding to the brightness control signal, and output a second frequency adjustment signal when the image enable signal is the valid level and the power supply signal reaches the reference power supply value corresponding to the brightness control signal; and
the frequency adjustment circuit is configured to, upon receiving the first frequency adjustment signal, control the controller to output the control signal of the first frequency; and upon receiving the second frequency adjustment signal, the controller is controlled to output the control signal of the second frequency.

4. The laser projection apparatus according to claim 3, wherein the frequency adjustment circuit comprises an external resistor circuit, the external resistor circuit being connected to the display control circuit and a frequency setting pin of the controller;
the external resistor circuit is configured to, upon receiving the first frequency adjustment signal, adjust a resistance value of the external resistor circuit to a first resistance value; and upon receiving the second frequency adjustment signal, adjust the resistance value of the external resistor circuit to a second resistance value; and
the controller is configured to, based on the external resistor circuit having the first resistance value, generate the control signal of the first frequency; and based on the external resistor circuit having the second resistance value, generate the control signal of the second frequency.

5. The laser projection apparatus according to claim 1, wherein the controller is further configured to enter a standby state when a first duration during which the image enable signal is the invalid level exceeds a predetermined duration; otherwise, it is not configured to enter the standby state, wherein the predetermined duration is not less than a period of the image enable signal.

6. The laser projection apparatus according to claim 5, wherein the laser projection apparatus further comprises a timing circuit, the timing circuit being coupled to the controller and the display control circuit, and configured to record the first duration and transmit a standby signal to the controller when the first duration exceeds the predetermined duration; and
the controller is configured to, upon receiving the standby signal, enter the standby state; otherwise, it is not configured to enter the standby state.

7. The laser projection apparatus according to claim 1, wherein the laser projection apparatus further comprises a frequency adjustment circuit, the frequency adjustment circuit being coupled to the controller; and
the frequency adjustment circuit is configured to adjust a frequency of the second control signal outputted by the controller.

8. The laser projection apparatus according to claim 7, wherein the display control circuit is further connected to the frequency adjustment circuit, the display control circuit being configured to output a frequency adjustment signal to the frequency adjustment circuit; and
the frequency adjustment circuit is configured to, based on the frequency adjustment signal, adjust the frequency of the second control signal outputted by the controller.

9. The laser projection apparatus according to claim 8, wherein the frequency adjustment circuit further comprises an external resistor circuit, the external resistor circuit being connected to the display control circuit and a frequency setting pin of the controller, and the external resistor circuit being configured to adjust a resistance value of the external resistor circuit according to the frequency adjustment signal, so as to adjust the frequency of the second control signal outputted by the controller.

10. The laser projection apparatus according to claim 9, wherein the external resistor circuit comprises a first switching tube, a first resistor, and a second resistor;
one terminal of the first switching tube is connected to the frequency setting pin of the controller and the other terminal of the first switching tube is connected to one terminal of the first resistor, and a control terminal of the first switching tube is connected to the display control circuit;
the other terminal of the first resistor is connected to ground; and
one terminal of the second resistor is connected to one terminal of the first switching tube and the frequency setting pin of the controller, and the other terminal of the second resistor is connected to the other terminal of the first resistor and is connected to the ground.

11. The laser projection apparatus according to claim 10, wherein the frequency of the second control signal outputted by the controller at least comprises a first operating frequency and a second operating frequency, wherein the first operating frequency is the frequency of the second control signal outputted by the controller when the first switching tube is turned off, the second operating frequency is the frequency of the second control signal outputted by the controller when the first switching tube is turned on; and a period of the controller working at the first operating frequency is not greater than a period of the controller working at the second operating frequency.

12. The laser projection apparatus according claim 1, wherein the driving circuit outputs an initial power supply current;
the laser projection apparatus further comprises a current adjustment circuit, wherein the current adjustment circuit is connected to the driving circuit and the at least one laser unit, and the current adjustment circuit is configured to, based on a comparison result of the initial power supply current and a reference current, adjust a current flowing through the at least one laser unit, such that an absolute value of a difference between the current flowing through the at least one laser unit and the reference current is less than an absolute value of a difference between the initial power supply current and the reference current.

13. The laser projection apparatus according to claim 12, wherein one terminal of the current adjustment circuit is connected to an output terminal of the at least one laser unit control circuit and an input terminal of the at least one laser unit, and the other end of the current adjustment circuit is connected to an output terminal of the at least one laser unit; and
the current adjustment circuit is configured to control the current flowing through the at least one laser unit to be less than the initial power supply current when the initial power supply current is greater than the reference current.

14. The laser projection apparatus according to claim 13, wherein the current adjustment circuit comprises a first control subcircuit and a first current-control subcircuit;
the first control subcircuit is connected to the input terminal of the at least one laser unit, and the first control subcircuit is configured to output a first current adjustment signal in a first state when the initial power supply current is greater than the reference current and output a first current adjustment signal in a second state when the initial power supply current is not greater than the reference current;
the first current-control subcircuit comprises a second switching tube, one terminal of the second switching tube being connected to the output terminal of the at least one laser unit control circuit and the input terminal of the at least one laser unit, the other end of the second switching tube being connected to an output end of the at least one laser unit, and a control terminal of the second switching tube being connected to the first control subcircuit; and
the first current-control subcircuit is configured to, based on the first current adjustment signal in the first state, control a current flowing through the second switching tube, and based on the first current adjustment signal in the second state, turn off the second switching tube.

15. The laser projection apparatus according to claim 14, wherein the display control circuit is further connected to the at least one laser unit control circuit, and the display control circuit is configured to, based on the current flowing through the second switching tube, adjust the light source driving signal, so as to increase the reference current.

16. The laser projection apparatus according to claim 12, wherein one terminal of the current adjustment circuit is connected to an output terminal of the at least one laser unit control circuit, and the other end of the current adjustment circuit is connected to an output terminal of the at least one laser unit control circuit and an input terminal of the at least one laser unit; and
the current adjustment circuit is configured to control the current flowing through the at least one laser unit to be greater than the initial power supply current when the initial power supply current is less than the reference current.

17. The laser projection apparatus according to claim 16, wherein the current adjustment circuit comprises a second control subcircuit and a second current-control subcircuit;
the second control subcircuit is connected to the input terminal of the at least one laser unit, and the second control subcircuit is configured to output a second current adjustment signal in a first state when the initial power supply current is less than the reference current and outputting a second current adjustment signal in a second state when the initial power supply current is not less than the reference current;
the second current-control subcircuit comprises a fourth switching tube, one terminal of the fourth switching tube being connected to the output terminal of the at least one laser unit control circuit, and the other end of the fourth switching tube being connected to the output terminal of the at least one laser unit control circuit and the input terminal of the at least one laser unit; and
the second current-control subcircuit is configured to, based on the second current adjustment signal in the first state, control a current flowing through the fourth switching tube, and based on the second current adjustment signal in the second state, turn off the fourth switching tube.

18. A control method, wherein the control method is applied to the laser projection apparatus according to claim 1, and the control method comprises:
emitting, by the at least one laser unit, a laser beam to provide the laser projection apparatus with an illumination beam;
outputting, by the display control circuit, a light source driving signal and an image display driving signal, the light source driving signal comprising an image enable signal and a brightness control signal;
modulating, by the light modulation device, the laser beam under the drive of the image display driving signal;
receiving, by the projection lens, the modulated laser beam, and performing projection imaging;
generating, by the controller, a control signal based on the image enable signal and the brightness control signal; and
generating, by the driving circuit, a power supply signal for supplying power to the corresponding laser unit based on the control signals,
wherein the control signals comprises a first control signal and a second control signal, the first control signal being a constant-level signal outputted by the controller when the image enable signal is converted from an invalid level to a valid level and the power supply signal does not reach a reference power supply value corresponding to the brightness control signal; and the second control signal being a PWM signal outputted by the controller when the image enable signal is the valid level and the power supply signal reaches the reference power supply value corresponding to the brightness control signal.

19. The control method according to claim 18, wherein the laser projection apparatus further comprises a frequency adjustment circuit, the frequency adjustment circuit being coupled to the controller;
the frequency adjustment circuit is configured to control the controller to output a control signal with a first frequency when the image enable signal is converted from the invalid level to the valid level and the power supply signal does not reach the reference power supply value corresponding to the brightness control signal, and control the controller to output a control signal with a second frequency when the image enable signal is the valid level and the power supply signal reaches the reference power supply value corresponding to the brightness control signal;
wherein the first frequency is less than the second frequency, the control signal of the first frequency comprising the first control signal and the control signal of the second frequency comprising the second control signal.

20. A laser unit control circuit, wherein the laser unit control circuit comprises a controller and a driving circuit;
the controller is connected to a display control circuit and the driving circuit, and the controller is configured to generate a control signal based on an image enable signal and a brightness control signal; and
the driving circuit is connected to a corresponding laser unit, and the driving circuit is configured to generate, based on the control signal, a power supply signal for supplying power to the corresponding laser unit,
wherein the control signal comprises a first control signal and a second control signal, the first control signal being a constant-level signal outputted by the controller when the image enable signal is converted from an invalid level to a valid level and the power supply signal does not reach a reference power supply value corresponding to the brightness control signal; and the second control signal being a PWM signal outputted by the controller when the image enable signal is the valid level and the power supply signal reaches the reference power supply value corresponding to the brightness control signal.
